(19) United States
(12) Patent Application Publication
(10) Pub. No.: US 2023/0300654 A1
(43) Pub. Date: Sep. 21, 2023

(54) Methods, UE and Network Node for Failure Predictions

(71) Applicant: Telefonaktiebolaget LM Ericsson (publ), Stockholm (SE)

(72) Inventors: Icaro L. J. Da Silva, Solna (SE); Victor Farias Monteiro, Fortaleza (BR); Mehdi Abad, Ankara (TR); Semiha Tedik Basaran, Istanbul (TR)

(21) Appl. No.: 18/011,240

(22) PCT Filed: Aug. 20, 2020
(86) PCT No.: PCT/SE2020/050803

§ 371 Date: Dec. 19, 2022

(30) Foreign Application Priority Data
Jul. 3, 2020 (EP) 20404004.2

(51) Int. Cl. H04W 24/10

(52) U.S. Cl. CPC H04W 24/10

(57) ABSTRACT

The present disclosure relates to a method performed by a UE (103) of a wireless communications network (100). The UE (103) predicts information related to at least one of the following failures: a failure during operation with a serving cell; and a failure accessing a neighbour cell. The UE (103) transmits a message to a network node (101). The message indicates the predicted information.

### TECHNICAL FIELD

The present disclosure relate to a User Equipment (UE), a method performed by the UE, a network node and a method performed by the network node.

### BACKGROUND

### Measurement Framework in NR/LTE

In Long Term Evolution (LTE) and Fifth Generation (5G) New Radio (NR), a mobility function may benefit from measurement reports that are configured by the serving network node where the UE is connected to. The serving network node may also be referred to as a source network node. The source network node configures the UE to detect cells in a given frequency, e.g. Primary Cell (PCell) frequency, for intra-frequency handover, without providing a list of cells to the UE. To assist intra-frequency handovers, the network node configures either periodic measurement reports or configures an A3 event, in a reportConfig associated to a measurement object and associated to a measurement identity, that is triggered when one of the neighbor cells in the frequency associated to the indicated measurement object, e.g. the same PCell frequency in case of intra-frequency handovers, becomes an offset better than the PCell. When the event is triggered for at least one cell, a measurement report is transmitted, and the serving network node may request a handover preparation via Xn, where resources are reserved in the target cell for an incoming UE.

In summary, the UE may be configured by the network to perform Radio Resource Management (RRM) measurements, typically called RRM/L3 measurements, and report them periodically or based on the triggering of configured events.

In the case of NR, the network may configure an RRC_CONNECTED UE to perform measurements and report them in accordance with the measurement configuration. The abbreviation RRC is short for Radio Resource Control. The measurement configuration is provided by means of dedicated signaling, i.e. using the RRCReconfiguration or RRCResume. The network may configure the UE to perform the following types of measurements: NR measurements; Inter-RAT measurements of E-UTRA frequencies.

The abbreviation RAT is short for Radio Access Technology and E-UTRA is short for Evolved Universal Terrestrial Access.

The network may configure the UE to report the following measurement information based on SS/PBCH block(s): Measurement results per SS/PBCH block; Measurement results per cell based on SS/PBCH block(s); SS/PBCH block(s) indexes.

The network may configure the UE to report the following measurement information based on Channel State Information-Reference Signal (CSI-RS) resources: Measurement results per CSI-RS resource; Measurement results per cell based on CSI-RS resource(s); CSI-RS resource measurement identifiers.

In legacy handovers, the serving network node contacts a target network node only when it is certain that a handover needs to be performed. Until then, there is no contact with the neighbor node to configure measurements, at least for LTE measurements based on cell-specific reference signals and NR measurements based on SS/PBCH Blocks (SSBs), which can only be detected once the frequency location is known. The abbreviation SS is short for Synchronization Signals and PBCH is short for Physical Broadcast Channel.

### Radio Link Failure (RLF) Framework

In the case of an A3 event being configured, the network expects the UE to report when it finds a neighbor cell that is better than its Special Cell (SpCell). Upon receiving these measurements, the network takes a decision whether it should handover the UE to that neighbor cell or not. If all goes fine, the network node decides to keep the UE connected to the serving cell, or to hand it over.

However, things may go wrong e.g. due to mistuned parameters, like the time to trigger or thresholds, and the UE may not trigger the report of measurements associated to an A3 event before the connection becomes so poor that it is not even possible to properly decode a downlink control channel, e.g. Physical Downlink Control Channel/Control Resource Set (PDCCH/CORESET). In that case, as it may also not be possible to notify the network, e.g. if the Uplink (UL) is also degraded so that measurement reports are not properly received at the network, that a problem is happening, The Third Generation Partnership Project (3GPP) has defined in LTE and NR a procedure called RLF declaration that consists of letting the UE perform an assessment of connection quality and, if the connection becomes bad, as an indication that the UE may not be able to contact the network or as an indication that the UE may not be able to be contacted by the network, the UE performs autonomous actions, such as the triggering of an RRC re-establishment procedure. In other words, in traditional handovers, until Release-15 (Rel-15) of NR or LTE, measurement reports are configured so that the network can detect when a cell in a particular frequency is better than the SpCell. Then, upon the reception of a measurement report the network may trigger a handover. Radio conditions may drop while the UE is sending measurement reports and/or the serving network node in the network is trying to transmit a handover command, an RRCConnectionReconfiguration with MobilityControlInfo in LTE or an RRCReconfiguration containing a reconfigurationWithSync in NR.

Upon detecting a radio problem, the UE starts a timer T1, timer T310 in RRC. If there is no recovery while the timer is running, that timer expires, and the UE declares RLF and starts a second timer T2, timer T311 in RRC, while it tries to perform cell selection and initiates further actions, such as reestablishment, if the UE is in single connectivity i.e. not operating in Multi-Radio-Dual Connectivity (MR-DC).

### RLF Related Prediction

RLF prediction as a general concept is something that has been previously mentioned. For example, it has been proposed to use Machine Learning (ML) to predict session drops, which may be driven by RLF, well before the end of session. ML provides higher accuracy than using traditional models. The use of ML has been applied and tested on live LTE data offline, where the model is placed at the network side, e.g. in an Operation and Maintenance (OAM) node. The high accuracy predictor can be part of a Self-Organizing Network (SON) function in order to eliminate the session drops or mitigate their effects. It also relies on data reported by the UE and Artificial Intelligence (AI)/ML models executed on the network side.

An autonomous cell or beam handover with support from network has also been proposed. The main idea for this relies on UEs predicting signal condition of serving and neighbor Base Stations (BS) and using these predictions as input to determining, in advance, if a Handover (HO) will fail or succeed. Based on this, the UE indicates to its serving BS to which neighbor BS it wants to handover.

US 9,826,419 B2 discloses that a UE stores, in a cell information database, cell related information, e.g., cell configuration information and RLF occurrences. Then, a UE should continuously check in the database if an RLF is predicted to happen using its current state as an entry in the database. If the UE determines that an RLF is predicted to happen, the UE will try to acquire a new cell, where acquiring a new cell is defined as a result of one of the following procedures: initialization, handover, selection or reselection.

The declaration of an RLF at the UE is specified so that the UE performs autonomous actions while in RRC _CONNECTED mode. Examples of autonomous actions are a RRC re-establishment procedure, Secondary Cell Group (SCG) failure report transmission, Conditional handover execution upon a failure, or Master Cell Group (MCG) failure report transmission. This is done under the assumption that when the RLF is declared there might be problems for the network to contact the UE, e.g. to possibly change its configuration, trigger a handover/reconfiguration with sync, or for the UE to notify these problems to its SpCell, e.g. by sending a possibly triggered measurement report. As any of these procedures lead to some service discontinuity to a UE and/or signaling exchanged with the network, it should be avoided as much as possible. However, this is not always possible.

The mobility framework based on measurement configurations and reporting is the primary way to reduce the risks of RLF, however, experience shows that in practice RLF(s) still occur.

Even if existing prior art mentions RLF predictions, there are some problems associated to it as explained hereinafter.

In prior art, RLF prediction models are placed and run at the network side, i.e., the UE needs to report whatever is used as input to these models to the network. That may increase the signaling load if this is continuously transmitted and quickly drain the UE battery, e.g. if the UE needs to report Global Positioning System (GPS) location. In addition to this, there may be valuable input to RLF predictions models the network is not even aware that the UE has access to e.g. information from sensors.

The RLF predictions are used as input to SON function(s) i.e. an offline process to tune parameters, such as an A3 threshold for Reference Signal Received Power (RSRP), Reference Signal Received Quality (RSRQ) or Signal to Interference plus Noise Ratio (SINR). Hence, these are not operating in a real-time or near real-time fashion, but as a way to tune parameters.

There is information locally placed at the UE that may affect its performance and may influence an RLF declaration that is unknown to the network, which may negatively affect the accuracy of the model, unless the UE reports anything and everything that is locally available which is not practical or even possible to build.

US 9,826,419 B2 discloses that RLF predictions are performed by the UE. However, not informing the network about a predicted RLF, may lead to the UE to take further actions, which is not the desired behavior for a Connected UE, which should operate according to what the network wants. Besides, autonomous decisions taken at the UE side may not take into account information located only at the network side e.g. network load across different cells.

Therefore, there is a need to at least mitigate or solve these issues.

### SUMMARY

An objective of embodiments herein is therefore to obviate at least one of the above disadvantages and to reduce the risk for failures in a wireless communications network.

According to a first aspect, the object is achieved by a method performed by a UE of a wireless communications network. The UE predicts information related to at least one of the following failures: a failure during operation with the serving cell; and a failure accessing a neighbor cell. The UE transmits a message to a network node. The message indicates the predicted information.

According to a second aspect, the object is achieved by a method performed by a network node of a wireless communications network. The network node receives a message from a UE. The message indicates information predicted by the UE. The predicted information is related to at least one of the following failures: a failure during operation with the serving cell, and a failure accessing a neighbor cell.

According to a third aspect, the object is achieved by a UE of a wireless communications network. The UE is adapted to predict information related to at least one of the following failures: a failure during operation with the serving cell; and a failure accessing a neighbor cell. The UE is adapted to transmit a message to a network node. The message indicates the predicted information.

According to a fourth aspect, the object is achieved by a network node of a wireless communications network. The network node is adapted to receive a message from a UE. The message indicates information predicted by the UE. The predicted information is related to at least one of the following failures: a failure during operation with the serving cell, and a failure accessing a neighbor cell.

The present disclosure herein affords many advantages, of which a non-exhaustive list of examples follows:

Since the prediction of the information related to a failure is performed by the UE, it uses information which is locally available in the UE for the prediction. Use of the locally available information provides accurate predicted information which, when received by the network node, reduces the risk of failures in the wireless communications network.

An advantage of the present disclosure is that predictions of information related to failures enables the usage of locally available information at the UE as input to the prediction model without the need to periodic reporting. The information locally available at the UE may be e.g. information from sensors, information from the application layer like a route from a mapping App like google maps, UE impairments related to UE implementation, hardware specific input, etc. With this, the UE has lower signaling load compared to where prediction is performed by the network node.

Another advantage of the present disclosure is that upon reception of messages including more accurate predictions of information related to failures, as the UE has information not currently reported to the network that may be used as input to prediction models, the network node can take actions to avoid a failure, such as configure the UE to perform inter-frequency measurements for event triggered measurement reporting to possibly indicate the best cells in a neighbor frequency or means to improve the SINR, e.g. perform some beam management procedure and/or reconfiguration/activation/deactivation of Bandwidth Part(s) (BWP). An alternative may have been to configure these inter-frequency measurements when the UE resumes, establishes or setups a connection; however, the consequence would be that the UE would have spent longer time performing inter-frequency measurements. As many UEs would require measurement gaps for inter-frequency measurements, throughput and data rates would be sacrificed longer for that sake, so in a way the report of predictions of information related to failures has the potential to improve throughput, as it reduces the needs for measurement gaps, i.e., the timer the UE has measurement gaps configured.

Another advantage of the present disclosure is the fact that the report of predictions of information related to failure enables an efficient network controlled mobility mechanism even for higher frequencies, where the links may not be very stable due to weather sensitivity and Line-of-Sight (LOS) requirement, such as in mmWave and/or even higher frequencies, possibly expected to be used in the Sixth Generation (6G) time frame; and at the same time, benefiting from accurate failure prediction models executed by a UE, instead of relying on network based models

Another advantage of the present disclosure is that if the network receives predicted information related to failures it can inform the higher layers so that some kind of admission control can be performed on the buffer. This way the buffer does not build up and overflow does not happen.

Another advantage of the present disclosure is in the case of MR-DC with split bearer configuration. The network can, upon receiving the predicted information related to failure from the UE about Master Node (MN) or Secondary Node (SN), decide whether to duplicate or change the route of control plane or user plane data. For example, if split bearer is enabled for Signaling Radio Bearer 1 (SRB1), which carriers RRC messages, where RRC messages are routed through primary path and the UE predicts information related to failure for the primary path, but not the secondary path. The network may reconfigure the Packet Data Convergence Protocol (PDCP) routing parameters so that RRC messages are routed from the secondary path.

The present disclosure is not limited to the features and advantages mentioned above. A person skilled in the art will recognize additional features and advantages upon reading the following detailed description.

### BRIEF DESCRIPTION OF THE DRAWINGS

The present disclosure will now be described in more detail by way of example only in the following detailed description by reference to the appended drawings illustrating the embodiments and in which:

FIG. 1 is a schematic drawing illustrating a wireless communications network.

FIG. 2 is a signaling diagram illustrating a method.

FIG. 3 is a graph illustrating UE predictions.

FIG. 4 is a flow chart illustrating a method performed by the UE.

FIG. 5 is a flow chart illustrating a method performed by the network node.

FIG. 6a is a schematic drawing illustrating a UE.

FIG. 6b is a schematic drawing illustrating a UE.

FIG. 7a is a schematic drawing illustrating a network node.

FIG. 7b is a schematic drawing illustrating a network node.

FIG. 8 is a schematic block diagram illustrating a wireless communication network connected via an intermediate network to a host computer.

FIG. 9 is a schematic block diagram of a host computer communicating via a base station with a UE over a partially wireless connection.

FIG. 10 is a flowchart depicting a method in a wireless communication network comprising a host computer, a base station and a UE.

FIG. 11 is a flowchart depicting a method in a wireless communication network comprising a host computer, a base station and a UE.

FIG. 12 is a flowchart depicting a method in a wireless communication network comprising a host computer, a base station and a UE.

FIG. 13 is a flowchart depicting a method in a wireless communication network comprising a host computer, a base station and a UE.

The drawings are not necessarily to scale and the dimensions of certain features may have been exaggerated for the sake of clarity. Emphasis is instead placed upon illustrating the principle.

### DETAILED DESCRIPTION

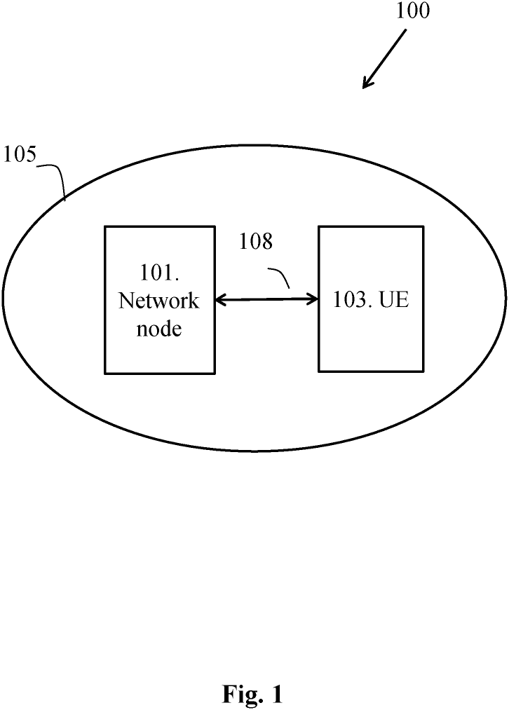

FIG. 1 depicts a non-limiting example of a wireless communications network 100, which sometimes may be referred to as a wireless communications system, a cellular radio system, or cellular network, in which the present disclosure may be implemented. The wireless communications network 100 may be a 5G system, 5G network, NR-U or Next Gen system or network. The wireless communications network 100 may be a younger or older system than a 5G system. The wireless communications network 100 may support other technologies such as, for example, Long-Term Evolution (LTE), LTE-Advanced/LTE-Advanced Pro, e.g. LTE Frequency Division Duplex (FDD), LTE Time Division Duplex (TDD), LTE Half-Duplex Frequency Division Duplex (HD-FDD), LTE operating in an unlicensed band, NB-IoT. Thus, although terminology from 5G/NR and LTE may be used in this disclosure to exemplify, this should not be seen as limiting to only the aforementioned systems.

The wireless communications network 100 comprises one or a plurality of network nodes, whereof a network node 101 is depicted in FIG. 1. The network node 101 may be a radio network node, such as a radio base station, or any other network node with similar features capable of serving a UE 103, such as a wireless device or a machine type communication device, in the wireless communications network 100. The network node 101 may be an eNB, a gNB, a MeNB etc.

The wireless communications network 100 covers a geographical area which may be divided into cell areas, wherein each cell area may be served by a network node, although, one network node may serve one or several cells. In FIG. 1, the wireless communications network 100 comprises a cell 105. A cell is a geographical area where radio coverage is provided by the network node 101 at a network node site. Each cell is identified by an identity within the local network node area, which is broadcast in the cell. In FIG. 1, network node 101 serves the cell 105. The network node 101 may be of a certain class, such as, e.g. macro base station (BS), home BS or pico BS, based on transmission power and thereby also cell size. The network node 101 may be directly connected to one or more core networks, which are not depicted in FIG. 1 for the sake of simplicity. The network node 101 may be a distributed node, such as a virtual node in the cloud, and it may perform its functions entirely on the cloud, or partially, in collaboration with another network node.

One or a plurality of UEs 103 is located in the wireless communication network 100. Only one UE 103 is exemplified in FIG. 1 for the sake of simplicity. A UE 103 may also be referred to simply as a device. The UE 103, e.g. a LTE UE or a 5G/NR UE, may be a wireless communication device which may also be known as e.g., a wireless device, a mobile terminal, wireless terminal and/or mobile station, a mobile telephone, cellular telephone, or laptop with wireless capability, just to mention some examples. The UE 103 may be a device by which a subscriber may access services offered by an operator’s network and services outside operator’s network to which the operator’s radio access network and core network provide access, e.g. access to the Internet. The UE 103 may be any device, mobile or stationary, enabled to communicate over a radio channel in the communications network, for instance but not limited to e.g. user equipment, mobile phone, smart phone, sensors, meters, vehicles, household appliances, medical appliances, media players, cameras, Machine to Machine (M2M) device, Internet of Things (IOT) device, terminal device, communication device or any type of consumer electronic, for instance but not limited to television, radio, lighting arrangements, tablet computer, laptop or Personal Computer (PC). The UE 103 may be portable, pocket storable, hand held, computer comprised, or vehicle mounted devices, enabled to communicate voice and/or data, via the radio access network, with another entity, such as another UE, a server, a laptop, a Personal Digital Assistant (PDA), or a tablet, Machine-to-Machine (M2M) device, device equipped with a wireless interface, such as a printer or a file storage device, modem, or any other radio network unit capable of communicating over a radio link in the wireless communication network 100.

The UE 103 is enabled to communicate wirelessly within the wireless communication network 100. The communication may be performed e.g. between two UEs 103, between the UE 103 and a regular telephone, between the UE 103 and the network node 101, between network nodes, and/or between the UEs 103 and a server via the radio access network and possibly one or more core networks and possibly the internet.

The network node 101 may be configured to communicate in the wireless communication network 100 with the UE 103 over a communication link 108, e.g., a radio link.

It should be noted that the communication links in the wireless communications network 100 may be of any suitable kind comprising either a wired or wireless link. The link may use any suitable protocol depending on type and level of layer, e.g. as indicated by the Open Systems Interconnection (OSI) model, as understood by the person skilled in the art.

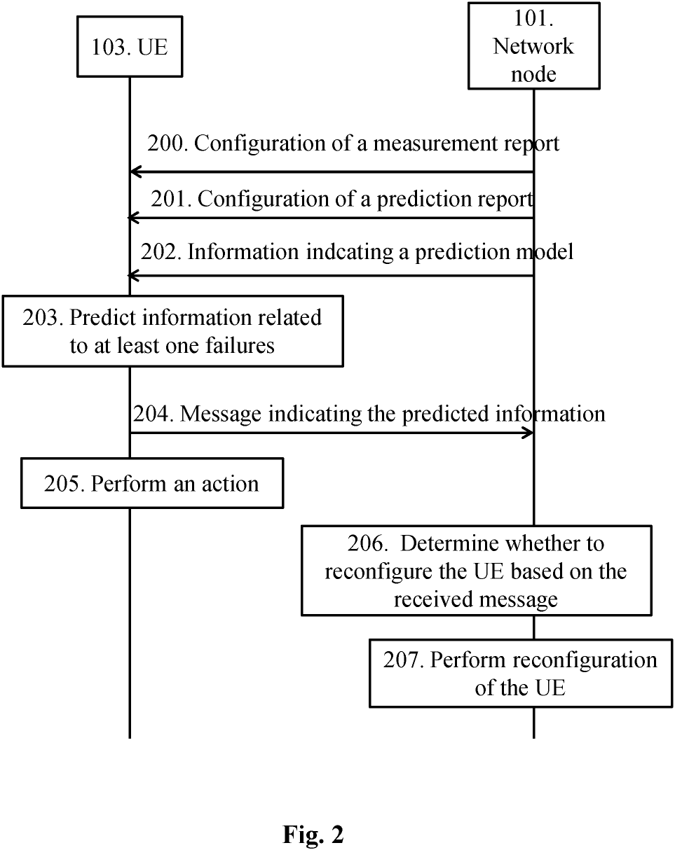

The method of the present disclosure will now be described with reference to the signaling diagram in FIG. 2. The method comprises the following steps, which steps may as well be carried out in another suitable order than the one described below.

### Step 200

The network node 101 may transmit a configuration of a measurement report to the UE 103 configuring one of:
periodic UE reporting of the measurement report; and
an entry condition triggering UE reporting of the measurement report.
The configuration further configures the UE 103 to include an indication of predicted information in the measurement report.

The UE 103 may receive the configuration of a measurement report from the network node 101.

This step 200 may also be described as the network node 101 may transmit a measurement configuration comprising at least a reporting configuration.

### Step 201

The network node 101 may transmit a configuration of a prediction report to the UE 103 configuring at least one of:
what information to predict; what to include in the prediction report;
an entry condition triggering the prediction report;
a period for reporting; and
an associated configuration of a measurement report to apply for the prediction report;

The UE 103 may receive the configuration of the prediction report from the network node 101.

### Step 202

The network node 101 may transmit information indicating a prediction model to use for predicting the information to the UE 103.

The UE 103 may receive the information indicating a prediction model to use for predicting the information from the network node 101.

### Step 203

The UE 103 predicts information related to at least one of the following failures:
a failure during operation with the serving cell, e.g. an RLF; and
a failure accessing a neighbor cell, e.g. a HO failure or reconfiguration with synch failure.

The predicted information may comprise at least one of:
a predicted failure declaration,
a reason for the predicted failure declaration,
a time of the predicted failure declaration,
a probability of the predicted failure declaration,
a prediction of events related to the failure,
a prediction of a measurement value related to the failure,
a prediction of a timer value related to the failure,
a prediction of a counter value related to the failure.

The predicted information may be related to at least one of a serving cell and a neighbor cell of the UE 103.

The predicted information may be based on measurements performed on downlink reference signal resources. The downlink reference signal resources may be for example at least one of SSB and CSI-RS. The downlink reference signal resource may be referred to as a DL beam.

Predicting the information may comprises:
the UE 103 may determine UE parameter values comprising at least one of: current measurement values, sensor values, connection parameter values, mobility history parameter values, current time values, and
the UE 103 may use the determined UE parameter values as input for a prediction model to use for predicting the information.

### Step 204

The UE 103 transmits a message to the network node 101. The message indicates the predicted information from step 203.

Transmitting the message may comprise transmitting the measurement report according to the received configuration of the measurement report from step 200.

Transmitting the message may comprise transmitting the prediction report according to the received configuration of the prediction report from step 201.

Configuration of the measurement or prediction report may comprise an identifier for each configured report, and the identifier may be comprised in the transmitted measurement or prediction report.

The network node 101 receives the message from the UE 103.

Receiving the message may comprise receiving the measurement report according to the transmitted configuration of the measurement report.

Receiving the message may comprise receiving the prediction report in accordance with the transmitted configuration.

The configuration of the measurement or prediction report may comprise an identifier for each configured report, and the identifier may be comprised in the received measurement or prediction report, received by the network node 101.

### Step 205

The UE 103 may perform an action in preparation for a re-establishment procedure, based on the predicted information. Examples of the action may be synchronization with a cell, e.g. neighbor cell with highest RSRP and/or RSRQ and/or SINR, and obtaining system information etc. The re-establishment procedure may result from a predicted failure.

### Step 206

The network node 101 may determine whether to reconfigure the UE 103 based on the received message.

Reconfiguration of the UE 103 may be one or more of the following:
Add configurations to the UE 103 to perform inter-frequency measurements e.g. if the reported predicted failure information indicates a certain likelihood of failure within a defined time;
Remove configurations from the UE 103 to perform inter-frequency measurements e.g. if the reported predicted failure information indicates a certain likelihood of failure within a defined time;
Conditional handover or reconfiguration, e.g. inter-frequency;
Handover /reconfiguration with sync, e.g. inter-frequency;
Addition, change or removal of an SCell;
Addition, change or removal of a PSCell; and
Routing/duplication (re)configuration of control plane and/or user plane data in case of MR-DC with split bearer.

### Step 207

The network node 101 may perform the reconfiguration of the UE 103 when determined to reconfigure the UE 103 in step 206.

Some more details of the method in FIG. 2 will now be provided.

The present disclosure relates to a prediction at the UE side of information related to failures, such as predictions of occurrence of failure at a given instant in time, e.g. indication that a failure may occur at a given instant in time, or predictions related to any other intermediate variable or parameter affecting the declaration of failure, such as predictions for the counters N310, N311, etc.

As described above in relation to step 203, the UE 103 performs predictions of information related to failures. The information may comprise at least one of the following:
an indication that a failure may be declared,
an indication of the reason why a failure may be declared, such as due to potential physical layer problems, potential expiry of timer T310, potential Media Access Control (MAC) protocol problems due to a possibly reach of the maximum number of preamble transmission attempts, potential failure problems due to a possibly reach of the maximum number of retransmissions,
predictions of further details concerning failure declaration such as predictions of the occurrence(s) of Out-of-Sync (OOS) events or In-Sync (IS) events, and
predictions of the SINR measurement used as input to determine an OSS event or IS event, etc.

Other examples of the predicted information related to failures are provided later.

The prediction of information related to failures may comprise prediction of a handover failure, or, in more general terms, prediction of a failure related to a reconfiguration with a sync procedure. For example, there may be an indication that a reconfiguration with sync failure may be declared, indication of the reason why a reconfiguration with sync failure may be declared, such as due to potential expiry of timer T304, potential MAC protocol problems due to a possibly reach of the maximum number of preamble transmission attempts, etc., predictions of further details concerning reconfiguration with sync failure declaration such as predictions of beam-specific measurements, e.g. SSB specific measurements, used for random access resource selection as defined in the MAC specifications. In that case, when a handover failure is predicted, the report of that information in a message, e.g. a measurement report, may indicate to the network node 101 that a given neighbor cell may not be a good candidate for handover, if a failure is predicted by the UE 103. Hence, the network node 101 may refrain to request a handover for the neighbor cells for which the UE 103 has reported predictions that handover failure may occur with a certain probability.

Predictions of information related to failure, or simply failure predictions, may be performed by the UE 103 according to configurations, i.e. fields and associated IEs comprising further fields/parameters, included in a measConfig of IE MeasConfig, especially in the alternative where predictions of information related to failures are to be comprised in a message, e.g. a measurement reports, whose criteria are also configured in measConfig of IE MeasConfig.

Alternatively, the reporting of information related to failure may be configured by a new field, e.g. called rlƒPredConfig of IE RlfPredConfig, comprising the configurations of predictions to be performed. The UE 103 may receive prediction reporting configuration(s) in step 201, e.g., new configuration in ReportConfigNR or a new IE for that RLF-PredictionReportConfig,and based on which the UE 103 may perform predictions of information related to failure in step 203.

The prediction report may comprise for example:
predictions of information related to failure and/or
a current state of variables related to failure such as:
   whether timer T310 is running or not,
   how much time is left at the moment of reporting for timer T310 expiry,
   the current value of counter N310 or how much is left for reaching its maximum value,
   how many RLC retransmissions are left before reaching its maximum value, possibly in addition to prediction.

Whether the above is comprised within a measurement report may be triggered according to the fulfillment of an entry condition, e.g. an A3 event, or reported periodically if configured by the network node 101.

The UE 103 may be configured to comprise predictions of information related to failure in measurement reports, e.g. triggered by an event like A3. For example, if cell A triggers an event A3 and leads to the transmission of a measurement report, the UE 103 may comprise predictions of information related to failure for the SpCell, e.g. the PCell. That measurement report may enable the network node 101 to identify how likely is that a failure, e.g. an RLF, may occur at the SpCell and decide whether a handover has to be performed or not at that point in time. If predictions of information related to failure for the neighbor cell(s) is also comprised in the measurement report, such as a triggered cell that fulfills the entry condition for the event, the network node 101 may identify a possible scenario where a handover may be followed by an RLF or, even identify the possibility of a Handover failure before it happens, and possibly choose another neighbor cell as handover candidate.

The UE 103 may receive and process an RRC message comprising configurations for predictions of information related to failure even if security has not been activated. This message or report may be called herein “prediction reports” or “failure prediction reports” due to the reason that predictions of information related to failure are comprised in the report. However, “prediction reports” is a generic term that may correspond to, for example, an RRCMeasurementReport that comprises measurements and predictions of information related to failure. Similarly, “prediction reports” may correspond to, for example, a new RRC message defined for reporting predictions e.g. RRCPredictionReport. That new message may have properties such as being transmitted on SRB1 and only after security has been activated.

Now, more examples of the predicted information related to failures will be provided. The predicted information related to failures may comprise at least one of the following, or any combination of them:
At least one indication that a failure may be declared:
   The indication may comprise a flag, e.g. that may be set to TRUE or FALSE, or similar;
   The indication may comprise an associated time information, indicating when the failure may occur;
   In the case of multiple indications, that may be a list or equivalent structure like a sequence of indications, for different time instances. There may be a list of indications for different time instances to indicate whether a failure is predicted to occur at a given point in time. For example, a list like this one [true true true true false] indicates that the failure is predicted to occur from the first time instance until the fourth, but not at the fifth.
   The indication may comprise a probability value indicating how likely is that the failure is going to be declared;
At least one indication of the reason a failure may possibly be declared according to the prediction; that may comprise at least one of the following;
   Physical layer problems;
   Expiry of timer T310;
   MAC protocol problems, due to a possibly reach of the maximum number of preamble transmission attempts, or any other random access problems;
   Failure problems due to a possibly reach of the maximum number of retransmissions;
   Expiry of timer T304;
   MAC protocol problems with a target cell while timer T304 is running, e.g., if the UE 103 would reach a maximum number of preamble transmission attempts.
Predictions of further details concerning failure declaration such as at least one of the following, for a particular possible problem:
   Predictions related to the physical layer, such as at least one of the following:
      Predictions of the occurrence(s) of OOS events or IS events
      Predictions of the SINR measurement used as input to determine an OOS event or IS event, etc.
      Predictions of when timer T310 is to expire or how much time would be left until that occurs;
      Predictions of when the counter N310 is to reach its maximum value, according to the configuration;
      Predictions of measurements, e.g. SINR of the SpCell, that is used as input to indicate that an OOS event or IS event is declared.
Information concerning an ongoing failure declaration procedure, not necessarily a prediction, but rather a state information, such as:
   Related to PHY layer:
      An indication related to timer T310;
      The indication may indicate that the timer T310 is running, if running;
      The indication may be the remaining time left for timer T310 to expiry, if running;
      The indication may be how much time has already passed since T310 has started, if running–
   An indication related for the counter N310:
      The indication may indicate that counter N310 has started to get counted, if it has.
      The indication may be the number of OOS events left for reaching the maximum number for the conter N310.
      The indication may be the number of OOS events that have occurred, indicating how close to maximum value N310 it is.
   An indication related for N311, similar to N310;
Related to the MAC layer:
   An indication related to number of preamble transmissions;
      The indication may indicate that the UE 103 is performing random access, i.e. it has transmitted at least one preamble and/or at least one retransmission.
      The indication may indicate the number of preamble transmissions left for reaching the maximum number of attempts.
      The indication may indicate the number of preamble transmissions that occurred, as another way to indicate how far from reaching the maximum number of attempts the UE 103 is when the information is reported.
Related to RLC layer:
   An indication related to number of RLC transmissions;
      The indication may indicate that the UE 103 is performing RLC retransmissions;
      The indication may indicate the number of RLC retransmissions left for reaching the maximum number of retransmissions.
      The indication may indicate the number of RLC retransmissions that occurred, as another way to indicate how far from reaching the maximum number of RLC retransmissions the UE 103 is when the information is reported.

Predictions of information related to failure may be performed for a serving cell, such as an SpCell, like the PCell or like a PSCell, if the UE 103 is operating in MR-DC.

Predictions of information related to failure may be performed for a neighbor cell, e.g. in a serving frequency or in a neighbor frequency. This may be useful when predictions of information related to failure are comprised in measurement reports that comprise measurements associated to a neighbor cell that may be a candidate for handover, dual connectivity, SCell addition/Activation/removal/deactivation, etc.

Predictions of information related to failure may be performed for a best neighbor in serving frequencies, e.g. if it is configured.

When performing the prediction of information related to failure in step 203, the UE 103 may use different inputs, different models etc. Below, this will be described in more detail. In the following, the parameters possibly used by the prediction model will be described.

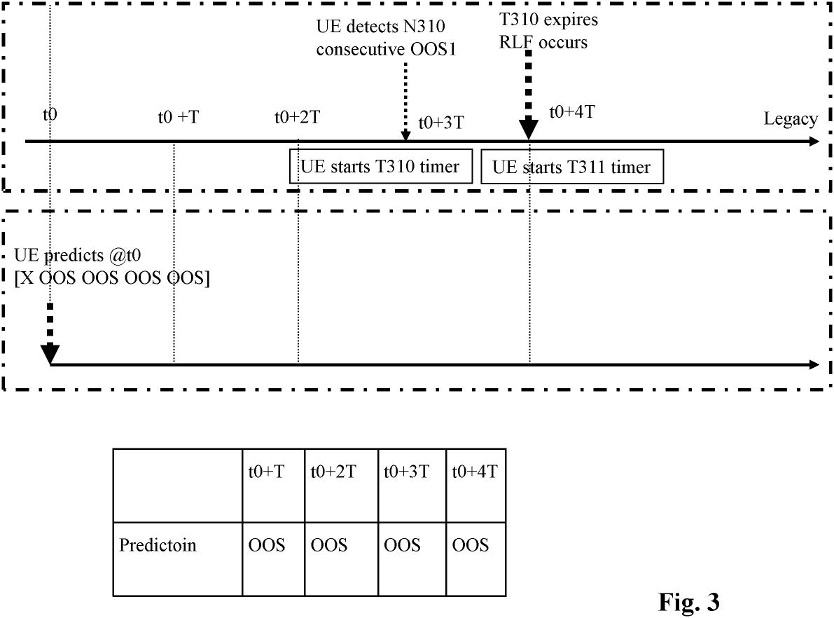

As seen in FIG. 3, at the end at the time t0, the UE 103 may be able to get a vector or list with a time series predictions for occurrences of OOS events, such as [X OOS OOS OOS OOS] with the first value at t0 meaning that all is fine, represented by an X, then one can see that at t0+T UE may predict an OOS event, same at t0+2T, same at t0+3T, so if N310*=3, where N310* may be something different for predictions compared to N310 for real failure, perhaps more conservative for predictions N310*>>N310, or even a mapping based on probabilities and N310* represents consecutive OOS predictions to predict starting T310 timer. Hence, somehow at t0+3T, the UE 103 may predict the occurrence the start of timer T310. Then, knowing the value of timer T310, the UE 103 may check further predictions, and also predict if OOS continues and/or no IS event is expected while timer T310 is running. For example, if timer T310* value = T, and at t0+4T there was no IS event, the UE 103 may predict the expiry of timer T310, hence, predict the failure declaration in advance, in this example, 4T in advance. By doing so, if measurement reports are being transmitted, that information may be comprised in the reports so that it may be helpful to the network node 101 to decide whether a handover shall be performed or not. Or, even if some reliability feature should be enabled e.g. DAPS and/or CHO and/or timer T312, etc.

In legacy, the UE 103 may declare the failure at t0+4T after the T310 timer expires. Thanks to the time series prediction at t+, the N310*, which represents the number of consecutive OOS predictions is required to predict starting the T310 timer. Therefore, the UE 103 predicts that the T310 timer will start at t0+3T by utilizing the time series prediction at t0. It is predicted that there will not be any IS event from t0+3T to t0+4T (T310*=T). Hence, the UE 103 may predict the failure declaration 4T in advance. If measurement reports are being transmitted, that information may be comprised in the reports so that it may be helpful to the network node 101 to decide whether a handover shall be performed or not.

In the case of NR, measurements for failure may be based on SSB or CSI-RS, or a mix of SSB and CSI-RS resources. The UE 103 may therefore perform predictions of information related to failure based on measurements performed either on SSBs and/or CSI-RS resources.

As mentioned above, the failure may be an RLF, a handover failure, or a reconfiguration with sync failure.

### Prediction Model

The UE 103 may use a prediction model when predicting the information related to failure. The prediction model may be referred to as a prediction function.

The UE 103 may receive a prediction model from the network node 101 in step 202 in FIG. 2. The prediction model may be implemented as a software function that is provided from the network node 101 to the UE 103, for example, in a procedure where the UE 103 downloads this software function. An alternative solution may rely on Application Protocol Interfaces (APIs) that may be exposed by the UE 103 to the network node 101, so an entity at the network node side may be able to configure a prediction model at the UE 103. In that case, there may be a procedure where the UE 103 indicates capability related information to the network node 101, i.e. the UE 103 may indicate to the network node 101 that it may download or receive a prediction model from the network node 101, for example, for mobility prediction information. This capability may be related to the software and hardware aspects at the UE 103, availability of sensors, etc. Once the UE 103 has the function available, it may be configured by the network node 101 to use it e.g. in a measurement configuration like reporting configuration, measurement object configuration, RLF configuration, Radio Link Monitoring (RLM) configuration, etc.

The network node 101 may take different input from the UE 103 to take a decision concerning the prediction model to provide the UE 103 and/or its configurations. For example, a network node 101, e.g., a BS or a cloud node, may receive the UEs′ 103 measurement reports and use them to train a Neural Network (NN), or the network node 101 may use failure reports and information within, indicating that a failure has occurred at some point in time. To train the NN, one may use as input to the NN signal measurements, e.g., RSRP, RSRQ or SINR, at instant “t”, and/or failure reports, and as output, the indication of whether a failure occurs or not at instant “t+X”. Thus, the NN may be able to predict if the failure occurs or not, “X” instants of time in advance. Since a NN may be characterized by the number of layers, number of nodes per layer and the nodes’ weights, after the training process, the network node broadcasts to the UEs 103 the NN parameters in order to allow the UEs 103 to reconstruct the NN and use it to predict future occurrences of failure. Since this is an example of supervised learning, from time to time, the network node 101 may update the NN weights based on new UEs′ 103 measurement reports and/or failure reports. The predicted values at instant “t” may be compared to the actual failure occasions at instant “t+X”, if any, in order to validate if the NN accuracy and to force, if necessary, the NN weights update.

It may be possible to rely on Federated Learning (FL). A group of UEs 103 may download the model and train, e.g., Stochastic Gradient Descent (SGD), the prediction model with their local data, e.g. RSRP, etc., on the UE 103. After a certain time, the UEs 103 may send their trained prediction model to the network node 101 and then network node 101 may take the average.

The UE 103 may have stored a prediction model, e.g., a UE proprietary prediction model, to perform the prediction of information related to failure. In that case, there may be a procedure where the UE 103 indicates to the network node 101 a capability related to that i.e. indicate that it may perform a certain prediction, e.g. prediction of information related to failure. A capability may be reported to the network node 101 in different levels of granularity such as
i) the UE 103 may have a prediction model and/or
ii) which exact prediction model the UE 103 has available, e.g., out of a list defined in the specifications and/or
iii) which kinds of predictions the model(s) the UE 103 has available performs and/or
iv) what kinds of input the model(s) the UE 103 has available take into account, etc.

It may be standardized at least one prediction model to be implemented at the UE 103 and configured by the network node 101, with a set of parameters. Many possibilities may be considered, for example: a NN, the UE 103 already knows that it will implement a NN of “L” layers, where each layer “i” has “Nᵢ” nodes, and each node “j” has a set of weights “Wⱼ”, but the values of “L”, “Nᵢ” and “Wⱼ” are set by the network node 101. Another possible model may be a Random Forest, where the network node 101 may set the number of estimators, e.g. trees in the forest, the depth of each tree and the threshold of each leaf. A capability may be reported to the network node 101 in different levels of granularity such as
i) UE 103 has a prediction model and/or
ii) which exact prediction model the UE 103 has available, e.g., out of a list defined in the specifications and/or
iii) which kinds of predictions the model(s) the UE 103 has available performs and/or
iv) what kinds of input the model(s) the UE 103 has available take into account, etc.

When it comes to the exact prediction model, one must first have in mind that a radio link may have usually less chances of being in a failure condition than of being in good conditions. So, one should consider this when preparing the data to be used to train a prediction model, if a supervised learning method is going to be used. Otherwise, if there is not a good balance between failure and success, the prediction model might be biased for one of the radio link states.

If the expected output is fail or success, traditional prediction models and also classification ones may be used. Regarding prediction model, it may be a feed-forward NN, where the inputs may be, but are not restrict to, current and/or predicted signal quality, e.g., RSRP, RSRQ, SINR, of serving and/or neighbor BSs/SSBs, current and/or predicted value of T310 and OOS, etc. Regarding classification models, e.g., Support Vector Machines (SVM) and K-Nearest Neighbor (KNN) may be used. These prediction models clusters data based on similar features into groups and then map new data to these formed groups.

### Parameters Used in the Prediction Model

Different prediction models may be used based on different set of parameters known at the UE 103.

Real or current measurements may be used as input parameters for the prediction model, e.g. RSRP, RSRQ, SINR at a certain point in time T0 for the same cells the UE 103 perform predictions, based on an RS type like SSB and/or CSI-RS and/or DRMS. The input parameters may be either instantaneous values or filtered values, e.g. with L3 filter parameters configured by RRC, from the serving and/or neighbor cells and/or serving or neighbor beams.

Parameters from sensors may be used as input parameters for the prediction model, such as UE positioning information, e.g. GPS coordinates, barometric sensor information or other indicators of height, rotation sensors, proximity sensors, and mobility such as, location information, previous connected BSs history, speed and mobility direction, information from mapping/guiding applications.

Metrics related to UE connection may be used as input parameters for the prediction model, such as average package delay. The UE 103 may also use input from sensors such as rotation, movement, etc. The UE 103 may use some route information, e.g. current location, final destination and route, as input.

UE mobility history information may be used as input parameters for the prediction model, such as last visited beams, last visited cells, last visited tracking areas, last visited registration areas, last visited RAN areas, last visited PLMNs, last visited countries, last visited cities, last visited states, etc.

Time information may be used as input parameters for the prediction model, such as the current time, e.g. 10:15 am, and associated time zone, e.g. 10:15 GMT. That may be relevant if the UE 103 has a predictable trajectory and it is typical that at a certain time the UE 103 is in a certain location.

Any failure related variable may be used as input parameters for the prediction model. The failure related variable may be an RLF related variable. The failure related variable may be at time instance t0 to predict the possible occurrence of a failure at time instance t0+kT such as at least one of the following, or any combination:
Related to PHY layer:
   An indication related to timer T310:
      The indication may indicate that timer T310 is running, if running.
      The indication may be the remaining time left for timer T310 to expiry, if running.
      The indication may be how much time has already passed since T310 has started, if running.
   An indication related for the counter N310:
      The indication may indicate that counter N310 has started to get counted, if it has.
      The indication may be the number of OOS events left for reaching the maximum number for the counter N310.
      The indication may be the number of OOS events that have occurred, indicating how close to the maximum value of the counter N310 it is.
   An indication related for a counter N311, similar to the counter N310.
Related to MAC layer:
   An indication related to number of preamble transmissions.
      The indication may indicate that UE 103 is performing random access, i.e. it has transmitted at least one preamble and/or at least one retransmission.
      The indication may indicate the number of preamble transmissions left for reaching the maximum number of attempts.
      The indication may indicate the number of preamble transmissions that occurred, as another way to indicate how far from reaching the maximum number of attempts the UE 103 is when the information is reported.
Related to RLC layer:
   An indication related to number of RLC transmissions.
      The indication may indicate that the UE 103 is performing RLC retransmissions.
      The indication may indicate the number of RLC retransmissions left for reaching the maximum number of retransmissions.
      The indication may indicate the number of RLC retransmissions that occurred, as another way to indicate how far from reaching the maximum number of RLC retransmissions the UE 103 is when the information is reported.

Predicted values of any of the previously mentioned parameters may be used, e.g., predicted value of a measurement, e.g., instantaneous and/or filtered RSRP/RSRQ/SINR based on SSB/CSI-RS, predicted UE position, predicted UE package delay, predicted number of OOS events to be used as input for predictions of information related to failure.

The UE 103 may be configured, e.g. by the network node 101, via an RRC message, to utilize at least one of the above parameters as input to the predictions model. The availability of these parameters, e.g. in case of sensors, the availability at the UE 103 of a sensor, like barometric sensor, may depend on a capability information indicated to the network node 101. If network node 101 is aware that the UE 103 is capable of performing certain failure predictions, like based on sensors, and, if the network node 101 is aware that a UE 103 benefits in using a parameter in a prediction model, UE 103 may be configured to use at least one of these input parameters in the prediction model for which the network node 101 is configuring the UE 103 to report.

In that case, the UE 103 may indicate capability related information to the network node 101, i.e. the UE 103 may indicate to the network node 101 that it can download or receive a prediction model from the network node 101, for example, for predicted information related to failure. This capability may be related to the software and hardware aspects at the UE 103, availability of sensors, etc. Once the UE 103 has the function available, it may be configured by the network node 101 to use it e.g. in a measurement configuration like reporting configuration, measurement object configuration, RLF configuration, RLM configuration, etc.

### Prediction Configuration

The predictions of information related to failure may be configured in various ways. Regardless of the way the UE 103 implements the model i.e. there may still be some configuration parameters from the network node 101.

The UE 103 may receive a prediction configuration, e.g. in step 201 in FIG. 2, in an RRC message, e.g. RRCResume, RRCReconfiguration, comprising per prediction to be performed, a prediction identifier, a reporting configuration identifier, e.g. associated to a reporting configuration, and an object identifier, e.g. associated to an object configuration. This prediction identifier may be included in the report when conditions are fulfilled, and predictions are to be reported to the network node 101.

The prediction configuration may be received in a predConfig field of IE PredConfig in an RRC message, e.g. RRCResume, RRCReconfiguration, comprising per prediction to be performed a prediction identifier represented by a predId of IE PredId, and a reporting configuration. The prediction configuration may indicate parameters indicating what exactly is to be predicted, e.g. any of the predictions of information related to failure, as listed earlier herein. The reporting configuration may indicate what is to be comprised in the report e.g. failure related information for serving cell, like the SpCell of the MCG, SpCell of the SCG, or neighbor cell(s), such as failure related information for the triggered cell associated to the event for the measurement report to be transmitted. In other words, it may be configurable what to include as prediction of failure related information.

The prediction of failure related information may be comprised in measurement reports, when these are triggered, e.g. when an entry condition for an event is fulfilled for all measurements for a given cell. As a measurement report is associated to a measId, measObject, reportConfig triplet configured via measConfig, the predictions to be comprised in the measurement report for a given measId may also be associated to that measId. For example, the configurations for what to be predicted and/or what to be comprised in the measurement report may be indicated in the same reportConfig of IE ReportConfigNR for example, or in the measObject of MeasObjectNR, or both, depending on the exact configuration. In this mixed case, for example, reportConfig may indicate the exact failure related information to be comprised, e.g. T310 related information, cause value, while in measObject the exact cell type for which failure information is to be reported e.g. if only for SpCell or neighbor cells in the frequency of the associated measurement object, e.g. include predictions of failure related information for the SpCell and/or neighbor cells in the frequency associated to the measurement object associated to that measId and reportConfig. An alternative may be to define a mapping/binding between the measId and the predId, so that both are associated to the same reportConfig and measObject.

Configurations for the predictions of failure related information may also be provided via broadcasted signaling e.g. in a system information block.

The UE 103 may perform predictions of information related to failure for at least one serving cell the UE 103 has been configured. That may be based on different criteria, depending on the presence or absence of various fields within the message. That may comprise at least one of the following cell types:
SpCell of the MCG.
SpCell of the SCG.
SCell of the MCG.
SCell of the SCG.

The UE 103 may predict information related to failure for at least one neighbor cell, e.g. in a neighbor frequency for which the UE 103 has a measurement object configured. That may be based on different criteria, depending on the presence or absence of various fields within the message. That may comprise at least one of the cell types:
Neighbor cell in the frequency of the SpCell of the MCG;
Neighbor cell in the frequency of the SpCell of the SCG;
Neighbor cell in the frequency of the SCell of the MCG;
Neighbor cell in the frequency of the SCell of the SCG;
Neighbor cell in any other neighbor frequency;

The above may be applicable if the UE 103 operates in single connectivity i.e. the UE 103 is only configured with an MCG.

### Predicted Information Comprised in a Message

The predicted information indicating a failure is transmitted from the UE 103 to the network node 101, as illustrated in step 204 in FIG. 2. The message may be a measurement report, a measurement message, a SCG failure report, a SCG failure message, a MCG failure report or a MCG failure message. The terms message and report may be used interchangeably herein.

### Measurement Report

The message in step 204 may be a measurement report. The predicted information related to failure may be comprised in a periodic measurement report. Hence, predictions of information related to failure may be comprised in the report before it is transmitted, periodically. That includes periodic updates of the predictions. For example, if at time t0 the UE 103 reports an indication and at time t0+T that prediction has changed an update is included.

The predicted information related to failure may be comprised in an event triggered measurement report. This is includes when an event is triggered, and the UE 103 initiates the measurement reporting procedure. In this case, there may be different benefits when it comes to the usage of these predictions on the network node side. Some events that may trigger the measurement report will now be described.

Event A1: An event A1 may be configured in reportConfig and associated to a measObject, for a serving frequency, and a measId. The entry condition may be considered fulfilled for the serving cell if all measurements after layer 3 filtering taken during the configured time to trigger fulfil the entry condition i.e. serving cell is better than a threshold.

Based on these A1 legacy reports the network node 101 may identify that a serving cell is recovering. Hence, one possible action may be to deactivate or remove possibly configured inter-frequency measurements at the UE 103, that consume UE power and reduces throughput as they may require measurement gaps. Hence, when predictions of information related to failure are comprised in the message in step 204, for the serving cell, the network node 101 may also be aware of the likelihood of a failure in the future and potential case, and may possibly not remove the configurations for inter-frequency measurements e.g. if the probabilities are higher than a certain value in the future, even if current measurements after filtering indicate that serving cell is good. An alternative may be that the network node 101 anyway removes these measurements and, when it receives a report of an A2 event, indicating that serving cell quality becomes poor, it may reconfigure it back, however, that may mean an additional signaling to configure inter-frequency measurements, while with the reported predictions of information related to failure, the network node 101 may understand if the improvement of the serving cell is really stable over time and if it is worth removing these inter-frequency measurement configurations. Another possible action based on predictions may be that the network node 101 may activate a configured SCell that becomes in good conditions, route traffic via an SCell or PSCell that becomes better, consider that as a candidate for a handover or reconfiguration with sync, e.g. in case that is not the PCell already, only if that serving cell also indicates a low risk of a failure according to the reported predictions. Event A2: An event A2 may be configured in reportConfig and associated to a measObject, for a serving frequency, and a measId. The entry condition may be considered fulfilled for the serving cell if all measurements after layer 3 filtering taken during the configured time to trigger fulfil the entry condition i.e. serving cell is worse than a threshold.

Upon reception of legacy A2 reports the network node 101 becomes aware that a given serving cell, e.g. the SpCell, is getting worse than a threshold. And, if the network node 101 has not received any A3 report for that frequency the network node 101 may configure inter-frequency measurements to possibly trigger an inter-frequency handover. Then, upon the reception of A2 messages that also comprise predictions of information related to failure, for example, for the serving cell being reported, the network node 101 may become aware that a given serving cell, e.g. the SpCell, is likely to suffer a failure within a certain time, which may indicate how worse it is getting and/or if there is a trend of that cell getting worse to the point of declaring a failure. And, if network node 101 has not received any A3 message, possibly comprising predictions of information related to failure for that frequency, the network node 101 may decide whether it may configure inter-frequency measurements to possibly trigger an inter-frequency handover and reduce the chances of failure. The network node 101 may also balance the risks with the consequences of early inter-frequency measurement configurations, such as the earlier need for measurement gaps, which may reduce throughput, and the higher power needed for inter-frequency measurements. The network node 101 may also use the predictions of information related to failure based on the A2 event to deactivate an active SCell or remove it, also depending on traffic demands. Another possibility may be to give the UE 103 higher priority in scheduling.

Event A3: An event A3 may be configured in reportConfig and associated to a measObject, for a serving frequency, and a measId. The entry condition may be considered fulfilled for a neighbor cell if all measurements after layer 3 filtering taken during the configured time to trigger fulfil the entry condition i.e. neighbor cell becomes offset better than SpCell, as shown below.

Upon reception of legacy A3 messages the network node 101 may become aware that a given neighbor cell in a given frequency, e.g. same frequency as the SpCell, is getting better than the SpCell for the trigger quantity, which means that it may be a good candidate for intra-frequency handover, corresponding to a reconfiguration with sync in NR. Then, upon the reception of an A3 message comprising predictions of information related to failure, e.g. indicating the likelihood of failure in the upcoming time instances, for the SpCell the network node 101 may be able to understand how critical it is to trigger a handover and/or inter-frequency measurements. And/or upon the reception of an A3 message comprising predictions of information related to failure, e.g. indicating the likelihood of failure in the upcoming time instances, for the triggered cells, the network node 101 may be able to understand how likely failures are to happen in a potential target cell if a handover is to be triggered. In other words, the network node 101 may try to avoid a too early handover and/or a handover to the wrong cell e.g. if a candidate with good radio conditions according to the measurement report indicates a high likelihood of failure after a number of time instances. Instead the network node 101 may configure inter-frequency measurements or select another target candidate with perhaps a lower risk of failure, despite not being the one with currently highest radio conditions, e.g. highest RSRP. If both predictions of information related to failure for the SpCell and for the triggered cells are available, comparison may be done at the UE 103.

Event A4: An event A4 may be configured in reportConfig and associated to a measObject, for a serving frequency, and a measId. The entry condition may be considered fulfilled for a neighbor cell if all measurements after layer 3 filtering taken during the configured time to trigger fulfil the entry condition i.e. neighbor cell is better than a threshold.

Upon reception of legacy A4 messages, the network node 101 becomes aware that a given neighbor cell is getting better than a threshold on an intra frequency band.

When predictions of information related to failure of the triggered neighbor cell are comprised in the message, the network node 101 may be also aware of the likelihood of failure in the future, or perhaps the likelihood of a handover failure and/or reconfiguration with sync failure. One possible action may be to activate further inter-frequency measurements if the probability of the triggered cell to present failure is higher than a threshold, even if current measurements after filtering indicate that neighbor cell is good. Otherwise, if the probability of failure is lower than a threshold, the network node 101 may configure the UE 103 to conditional handover to that cell, upon the occurrence of an A2 and/or an A3 event.

If predictions of information related to failure of the serving cell are also comprised in the message, e.g. the measurement report, the network node 101 may take even clever decisions regarding activating inter-frequency measurements and configuring conditional handover. For example, if failure is predicted for serving cell the network node 101 may even speed up an inter-frequency handover to the cell(s) for which A4 has been triggered.

The A4 event may be configured for inter-frequency measurements when the network node 101 does not receive any A3 messages. Including failure predictions within A4 messages may carry somewhat similar advantages as discussed in inclusion of failure predictions in the A3 message. Another advantage in receiving the failure prediction along A4 messages is that the network node 101 may conceive how critical the failure is to configure inter-RAT measurements. In CA, if supported by UE 103, the A4 event may also be used in SCells mobility decisions. When the A4 event is triggered by a neighborcell, on a different carrier component than the Spcell, then the network node 101 may choose to add the triggering cell as SCell. Moreover, if the UE 103 is already configured with Carrier Aggregation (CA) A4 message can be used for SCell change where the current SCell is removed and triggering neighbor cell is added as SCell. Adding or changing SCells requires signaling from PCell and introduces signaling overheads. Comprising predicted information related to failure in A4 messages may help to prevent unnecessary or wrong modifications of SCells. As an example, a neighborcell that triggers an A4 message may comprise predictions of failure in the near future. Based on this, the network node 101 may prevent signaling overhead due to wrong SCell modifications. In general, failure predictions may help the network node 101 to take SCell mobility decisions, addition/release/activation/deactivation, more efficiently. Similar advantages may be identified for SCG addition/modification/release/change in case of MR-DC.

Event A5: An event A5 may be configured in reportConfig and associated to a measObject, for a serving frequency, and a measId. The entry condition may be considered fulfilled if all measurements after layer 3 filtering taken during the configured time to trigger fulfill the entry condition, i.e., SpCell becomes worse than threshold1 and a neighbor cell becomes better than threshold2.

Upon reception of legacy A5 messages, the network node 101 may become aware that a given neighbor cell is getting better than a threshold1, while the SpCell is getting worse than other threshold2. A5 indicates that a neigbour cell, inter-frequency, becomes a better candidate than the PCell. The same advantages as indicated in event A3 holds as well for failure predictions included in A4 message.

When predictions of failure related to the triggered cells are comprised in the message, e.g. the measurement report, the network node 101 may be able to understand how likely failures are to happen to those cells. Based on this, the network node 101 may change measurement configuration, e.g. induce more frequent measurements, in order to confirm if the predictions are going to happen, activate inter-frequency measurement if both SpCell and neighbor intra-frequency cells are predicted to present failure, change A3 parameters, lower values of TTT, threshold, ... if failure is predicted to happen to SpCell and neighbor cell is predicted to not suffer from failure, in order to identify as soon as possible when neighbor cell becomes better than SpCell; configure a conditional handover.

Event A6: An event A6 may be configured in reportConfig and associated to a measObject, for a serving frequency, and a measId. The entry condition may be considered fulfilled if all measurements after layer 3 filtering taken during the configured time to trigger fulfill the entry condition i.e. neighborcell becomes offset better than SCell.

Upon reception of legacy A6 messages, the network node 101 may be aware that a neighbor cell becomes offset better than SCell. A6 message may be used in SCell mobility for changing SCells. In legacy reports, the network node 101 may choose to change the SCell based on the A6 message. However, due to high speed UE for example, the newly changed SCell quality may drop and the network may choose to release it. This results in signaling overheads. However, when the triggering neighborcell shows a failure event in future as indicated in A6 event that includes predicted information related to failure, the network node 101 may prevent unnecessary SCell change.

When predictions of failure related to the triggered cells are comprised in the message, e.g. the measurement report, the network node 101 may be able to understand how likely failures are to happen to those cells. Based on this, the network node 101 may configure the UE 103 to change the SpCell by the neighbor cell, if convenient.

As an example, if changes were to be introduced in RRC specifications to enable the feature, the following could be added as follows:

### 5.5.5 Measurement Reporting

### 5.5.5.1 General

The purpose of this procedure is to transfer measurement results (possibly including predictions of RLF related information) from the UE to the network. The UE shall initiate this procedure only after successful AS security activation.

For the measld for which the measurement reporting procedure was triggered, the UE shall set the measResults within the MeasurementReport message as follows:
1> set the measld to the measurement identity that triggered the measurement reporting;
1> for each serving cell configured with servingCellMO: [...]
   2> for each serving cell (e.g. SpCell of MCG, SpCell of SCG):
      3> set the rlf-predServingCell within measResultServingMOList to include predictions of RLF related information of the SpCell; [...]
1> if there is at least one applicable neighbouring cell to report:
   2> if the reportType is set to eventTriggered or periodical:
      3> set the measResultNeighCells to include the best neighbouring cells up to maxReportCells in accordance with the following:
         4> if the reportType is set to eventTriggered:
         5> include the cells included in the cellsTriggeredList as defined within the VarMeasReportList for this measld;
         4> else:
         5> include the applicable cells for which the new measurement results became available since the last periodical reporting or since the measurement was initiated or reset;
         4> for each cell that is included in the measResultNeighCells, include the physCellld;
         4> if the reportType is set to eventTriggered or periodical:
         5> for each included cell, include predictions of RLF related information as follows:
         6> set the rlf-vredServingCell within measResultNeighCells to include predictions of RLF related information;
      [...]
   2> else: [...]
1> if the corresponding measObject concerns NR: [...]
1> else:
   2> if the reportType is set to periodical:
      3> remove the entry within the VarMeasReportList for this measld;
      3> remove this measld from the measIdList within VarMeasConfig;
1> if the UE is in (NG)EN-DC:
   2> if SRB3 is configured:
      3> submit the MeasurementReport message via SRB3 to lower layers for transmission, upon which the procedure ends;
   2> else:
      3> submit the MeasurementReport message via the E-UTRA MCG embedded in E-UTRA RRC message ULInformationTransferMRDC as specified in TS 36.331 [10].
1> else if the UE is in NR-DC:
   2> if the measurement configuration that triggered this measurement report is associated with the SCG:
      3> if SRB3 is configured:
      4> submit the MeasurementReport message via SRB3 to lower layers for transmission, upon which the procedure ends;
      3> else:
      4> submit the MeasurementReport message via the NR MCG embedded in NR RRC message ULInformationTransferMRDC as specified in 5.7.2a.3;
   2> else:
      3> submit the MeasurementReport message via SRB1 to lower layers for transmission, upon which the procedure ends;
1> else:
   2> submit the MeasurementReport message to lower layers for transmission, upon which the procedure ends.
[...]

### MeasResults

The IE MeasResults covers measured results for intra-frequency, inter-frequency, and inter-RAT mobility.

MeasResults information element

| | |
|---|---|
| -- ASN1START | |
| -- TAG-MEASRESULTS-START | |
| MeasResults :: = | SEQUENCE { |
| measId | MeasId, |
| measResultServingMOList | MeasResultServMOList, |
| measResultNeighCells | CHOICE { |
| measResultListNR | MeasResultListNR, |
| ..., | |
| measResultListEUTRA | measResultListEUTRA |
| } | |
| OPTIONAL, | |
| ···, | |
| [...] | |
| } | |
| MeasResultServMOList ::= | SEQUENCE (SIZE (1..maxNrofServingCells)) OF |
| MeasResultServMO | |
| MeasResultServMO ::= | SEQUENCE { |
| servCellId | ServCellIndex, |
| measResultServingCell | MeasResultNR, |
| measResultBestNeighCell | MeasResultNR |
| OPTIONAL, | |
| rlf-predServingCell | RLF-relatedInfo OPTIONAL, |
| ... | |
| } | |
| RLF-relatedInfo : := | SEQUENCE { |
| predictionOccurence | SEQUENCE (SIZE (1..FFS)) OF BOOLEAN |
| timeRlfOccurence | FFS |
| rlfCause | SEQUENCE (SIZE (1..FFS)) OF RLF-Cause |
| } | |
| RLF-Cause: : = | ENUMERATED {t310, phy, mac, rlc} |
| MeasResultListNR :: = | SEQUENCE (SIZE (1..maxCellReport)) OF MeasResultNR |
| MeasResultNR :: = | SEQUENCE { |
| physCellId | PhysCellId |
| OPTIONAL, | |
| measResult | SEQUENCE { |
| cellResults | SEQUENCE{ |
| resultsSSB-Cell | MeasQuantityResults |
| OPTIONAL, | |
| resultsCSI-RS-Cell | MeasQuantityResults |
| OPTIONAL | |
| }, | |
| rsIndexResults | SEQUENCE{ |
| resultsSSB-Indexes | ResultsPerSSB_IndexList |
| OPTIONAL, | |
| resultsCSI-RS-Indexes | ResultsPerCSI-RS-IndexList |
| OPTIONAL | |
| } | |
| OPTIONAL | |
| }, | |
| rlf-predServingCell | RLF-relatedInfo OPTIONAL, |
| ..., | |
| [ [ | |
| cgi-Info | CGI-InfoNR |
| OPTIONAL | |
| ] ] | |
| } | |
| [...] | |
| -- TAG-MEASRESULTS-STOP | |
| -- ASN1STOP | |

RLF-relatedlnfo field descriptions
prediction Occurence
Each element indicates a TRUE when the UE predicts an RLF occurrent at the given time instance, otherwise it sets the element to FALSE.
timeRlfOccurence
Indicating when the RLF may occur according to an RLF prediction.
rlfCause
Indicates of the reason an RLF may possibly be declared according to the prediction.

### SCG/MCG Failure Reports

The above may be applicable if the UE 103 operates in multi connectivity, such as Multi-Radio Dual Connectivity (MR-DC). In that case, the predictions of information related to failure may be for the SCG or the MCG. The UE 103 may perform predictions of information related to failure associated to the MCG and/or SCG, and reporting to the MCG, e.g. via SRB1 terminated in the Master Node. For example, at least one of these may be comprised in a measurement report e.g. triggered by an event or periodically transmitted, or comprised in an SCG failure report, triggered to be transmitted to the MCG upon the detection of a failure at the SCG. An example of a network node action upon reception may be that the MCG failure report may to the SCG, i.e. to the SN, and possibly to the MCG, where the report may be forwarded, the situation at the MCG at the moment of the failure in terms of radio conditions, e.g. RSRP, RSRQ, and availability of possible neighbors in that SpCell frequency, which may be candidates for an MCG addition after the failure or, in future cases, a candidate for an MCG change/handover.

The UE 103 may perform predictions of information related to failure associated to the SCG and/or MCG and reporting to the SCG, e.g. via SRB3 terminated in the Secondary Node. For example, at least one of these may be comprised in a measurement report e.g. triggered by an event or periodically transmitted, or comprised in an MCG failure report, triggered to be transmitted to the SCG upon the detection of a failure at the MCG. An example of a network node action upon reception may be that an SCG failure report may indicate to the MCG, i.e. to the MN, and possibly to the SCG, where the report may be forwarded, the situation at the SCG at the moment of the failure in terms of radio conditions, e.g. RSRP, RSRQ, and availability of possible neighbors in that SpCell frequency, which may be candidates for an SCG addition after the failure or, in future cases, a candidate for an SCG change. The inclusion of predictions of information related to failure associated to the MCG may indicate how critical is to resolve the issue by e.g. adding a new SCG and/or trigger a handover, e.g. if the report indicates high likelihood of failure in a number of time instances. The inclusion of predictions of information related to failure associated to the SCG, in this case previous predictions by the UE 103, i.e. the past predictions, on the other hand, may indicate to which extent that failure has been predicted by the UE 103.

In DC, failure predictions may also be used as an indication to switch roles, e.g. master and secondary node, or to start searching for other cell to replace the one that will present failure. The method comprises the reporting of predictions of Radio Link Failure related information in a message.

The reporting may be done via measurement reporting. In other words, the UE 103 may transmit a measurement report comprising predictions of information related to failure. The reporting of predictions of information related to failure may be performed via SRB1. The reporting may be done via SRB3. The reporting may be done via an SCG Failure reporting. The reporting may be done via an MCG Failure reporting. The reporting may be done via a new procedure for reporting prediction of information related to failure.

### Network Node Receiving the Message

As seen in step 204, the network node 101 receives the message comprising the predicted information related to failure from the UE 103.

The reception of the UE message comprising predictions of information related to failure may be configured by the network node 101 as described earlier. For example, reporting configuration may be comprised in an RRCReconfiguration message transmitted to the UE 103, comprising a measConfig field of IE MeasConfig, which may be extended to enable the configuration of reporting of predictions related to failure. An alternative may be use a new field predConfig of IE PredConfig.

The reception of reports from the UE 103 may be via at least one of the following mechanisms:
Monitoring of an SRB 1 on the network node side, to receive measurement reports or any type of prediction report containing predictions of information related to failure.
Monitoring of an SRB3 on the network node side, to receive measurement reports or any type of prediction report containing predictions of information related to failure.
Monitoring the reception of an SCG Failure report.
Monitoring the reception of an MCG Failure report;

### Determining to Reconfigure the UE

As seen in step 206 of FIG. 2, the network node 101 may determine whether to reconfigure the UE 103 based on the received message from step 204. Upon reception of predictions of information related to failure from a given UE 103, the network node 101 may perform at least one of the following actions in terms of configuring/re-configuring the UE reporting the information:
Add configurations to the UE 103 to perform inter-frequency measurements e.g. if the reported failure prediction information indicates a certain likelihood of failure within a defined time.
Remove configurations to the UE 103 to perform inter-frequency measurements e.g. if the reported failure prediction information indicates a certain likelihood of failure within a defined time.
Conditional handover or reconfiguration, e.g. inter-frequency.
Handover /reconfiguration with sync, e.g. inter-frequency.
Addition, change or removal of a SCell.
Addition, change or removal of a PSCell.
Routing/duplication (re)configuration of control plane and/or user plane data in case of MR-DC with split bearer.
Further configuration such as for example different actions depending on the event triggered reports that have been received, like A1, A2, A3, A4, A5, A6, B1, B2, etc.

The network node 101 may transmit to the UE 103 an RRCReconfiguration comprising at least one of the configurations mentioned above. The network node 101 may transmit to the UE 103 an RRCRelease message, possibly comprising redirect information, e.g., in response to the reported prediction of information related to failure.

There may be an inter-node communication between the network node 101 and another network node, e.g. a second network node, where the network node 101 transmits to the other network node predictions of information related to failure. The predictions of information related to failure may be performed at the network node 101. The predictions of information related to failure may be reported by the UE 103 and comprised in an inter-node message that is transmitted to the other network node. The other network node may receive the predictions of information related to failure and may prepare a reconfiguration for the associated UE 103 taking that into consideration. For example, if the report indicates that in a given cell in a given frequency, e.g. cell-A in frequency X, the UE 103 may have some chance to experience failure and/or handover failure or reconfiguration with sync failure, the other network node may consider that cell not as a good candidate for adding as an SCell or SpCell of a Secondary Cell Group.

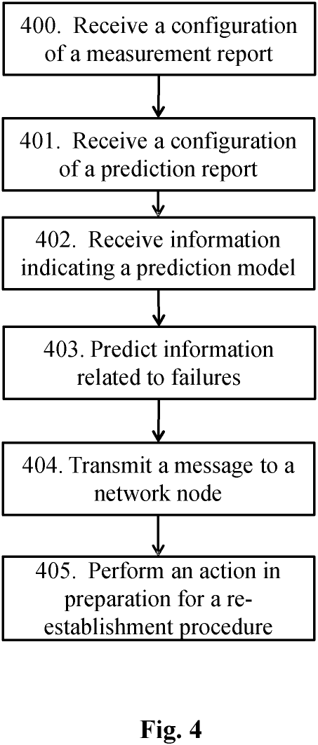

The method described above will now be described seen from the perspective of the UE 103. FIG. 4 is a flowchart describing the present method in the UE 103. The method comprises at least one of the following steps to be performed by the UE 103, which steps may be performed in any suitable order than described below:

### Step 400

This step corresponds to step 200 in FIG. 2. The UE 103 may receive a configuration of a measurement report from the network node 101. The configuration may configure one of:
periodic reporting of the measurement report; and
an entry condition triggering reporting of the measurement report.

The configuration may further configure the UE 103 to include an indication of the predicted information in the measurement report.

This step may also be described as the UE 103 may receive a measurement configuration comprising at least a reporting configuration.

### Step 401

This step corresponds to step 201 in FIG. 2. The UE 103 may receive a configuration of a prediction report from the network node 101. The configuration of the prediction report may configure at least one of:
what information to predict;
what to include in the prediction report;
an entry condition triggering the prediction report;
a period for reporting; and
an associated configuration of a measurement report to apply for the prediction report.

The configuration of the measurement or prediction report may comprise an identifier for each configured report.

### Step 402

This step corresponds to step 202 in FIG. 2. The UE 103 may receive information indicating a prediction model to use for predicting the information from the network node 101.

### Step 403

This step corresponds to step 203 in FIG. 2. The UE 103 predicts information related to at least one of the following failures:
a failure during operation with the serving cell; and
a failure accessing a neighbor cell.

The predicted information may comprise at least one of:
a predicted failure declaration,
a reason for the predicted failure declaration,
a time of the predicted failure declaration,
a probability of the predicted failure declaration,
a prediction of events related to the failure,
a prediction of a measurement value related to the failure,
a prediction of a timer value related to the failure, and
a prediction of a counter value related to the failure.

The predicted information may be related to at least one of a serving cell and a neighbor cell of the UE 103.

The predicted information may be based on measurements performed on downlink reference signal resources.

The UE 103 may determine UE parameter values comprising at least one of: current measurement values, sensor values, connection parameter values, mobility history parameter values, current time values. The UE 103 may use the determined UE parameter values as input for a prediction model to use for predicting the information.

### Step 404

This step corresponds to step 204 in FIG. 2. The UE 103 transmits a message to a network node 101. The message indicates the predicted information.

The UE 103 may transmit the measurement report according to the received configuration of the measurement report from step 400.

The UE 103 may transmit the prediction report according to the received configuration of the prediction report.

An identifier for each configured report, may be comprised in the transmitted measurement or prediction report.

### Step 405

This step corresponds to step 205 in FIG. 2. The UE 103 may perform an action in preparation for a re-establishment procedure, based on the predicted information. Examples of actions may be synchronization with a cell, e.g. neighbour cell with highest RSRP and/or RSRQ and/or SINR, and obtaining system information.

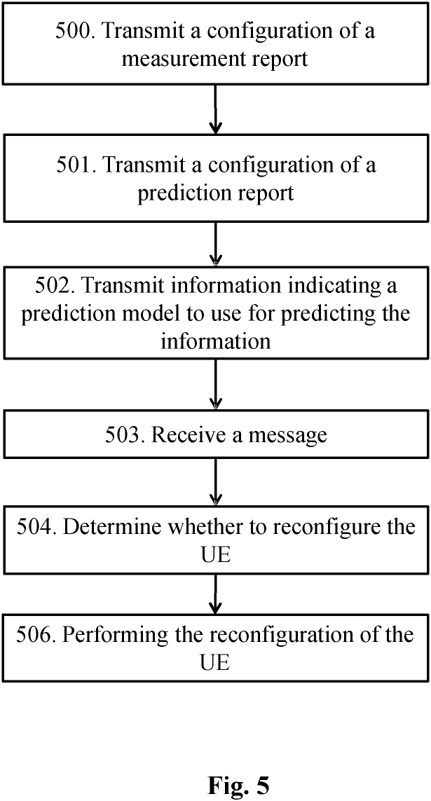

The method described above will now be described seen from the perspective of the network node 101. FIG. 5 is a flowchart describing the present method in the network node 101. The method comprises at least one of the following steps to be performed by the network node 101, which steps may be performed in any suitable order than described below:

### Step 500

This step corresponds to step 200 in FIG. 2. The network node 101 may transmit a configuration of a measurement report to the UE 103 configuring one of:
periodic UE reporting of the measurement report; and
an entry condition triggering UE reporting of the measurement report.

The configuration may further configure the UE 103 to include an indication of the predicted information in the measurement report.

This step may also be described as the network node 101 may transmit a measurement configuration comprising at least a reporting configuration

### Step 501

This step corresponds to step 201 in FIG. 2. The network node 101 may transmit a configuration of a prediction report to the UE 103 configuring at least one of:
what information to predict;
what to include in the prediction report;
an entry condition triggering the prediction report;
a period for reporting; and
an associated configuration of a measurement report to apply for the prediction report.

The configuration of the measurement or prediction report may comprise an identifier for each configured report.

### Step 502

This step corresponds to step 202 in FIG. 2. The network node 101 may transmit information indicating a prediction model to use for predicting the information to the UE 103.

### Step 503

This step corresponds to step 204 in FIG. 2. The network node 101 receives a message from the UE 103. The message indicates information predicted by the UE 103. The predicted information is related to at least one of the following failures:
a failure during operation with the serving cell; and
a failure accessing a neighbor cell.

Receiving the message may comprise receiving the measurement report according to the transmitted configuration of the measurement report.

Receiving the message may comprise receiving the prediction report in accordance with the transmitted configuration.

The identifier for each configured report may be comprised in the received measurement or prediction report.

The predicted information may comprise at least one of:
a predicted failure declaration,
a reason for the predicted failure declaration,
a time of the predicted failure declaration,
a probability of the predicted failure declaration,
a prediction of events related to the failure,
a prediction of a measurement value related to the failure,
a prediction of a timer value related to the failure, and
a prediction of a counter value related to the failure.

The predicted information may be related to at least one of a serving cell and a neighbor cell of the UE 103.

### Step 504

This step corresponds to step 206 in FIG. 2. The network node 101 may determine whether to reconfigure the UE 103 based on the received message.

### Step 505

This step corresponds to step 207 in FIG. 2. The network node 101 may perform the reconfiguration of the UE 103 when determined to reconfigure the UE 103.

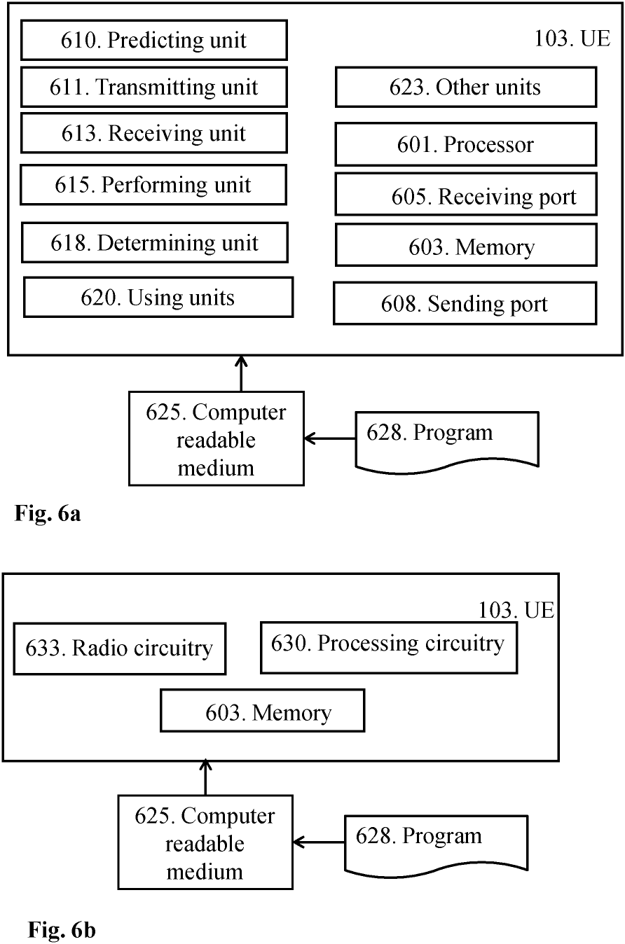

To perform the method steps shown in FIG. 4, the UE 103 may comprises an arrangement as shown in FIG. 6a or FIG. 6b. FIG. 6a and FIG. 6b depict two different examples in panels a) and b), respectively, of the arrangement that the UE 103 may comprise.

The present disclosure related to the UE 103 may be implemented through one or more processors, such as a processor 601 in the UE 103 depicted in FIG. 6a, together with computer program code for performing the functions and actions described herein. A processor, as used herein, may be understood to be a hardware component. The program code mentioned above may also be provided as a computer program product, for instance in the form of a data carrier carrying computer program code for performing the present disclosure when being loaded into the UE 103. One such carrier may be in the form of a CD ROM disc. It is however feasible with other data carriers such as a memory stick. The computer program code may be provided as pure program code on a server and downloaded to the UE 103.

The UE 103 may comprise a memory 603 comprising one or more memory units. The memory 1003 is arranged to be used to store obtained information, store data, configurations, schedulings, and applications etc. to perform the methods herein when being executed in the UE 103.

The UE 103 may receive information from, e.g. the network node 101, through a receiving port 605. The receiving port 605 may be, for example, connected to one or more antennas in UE 103. The UE 103 may receive information from another structure in the wireless communications network 100 through the receiving port 605. Since the receiving port 605 may be in communication with the processor 601, the receiving port 605 may then send the received information to the processor 601. The receiving port 605 may also be configured to receive other information.

The processor 601 in the UE 103 may be configured to transmit or send information to e.g. network node 101 or another structure in the wireless communications network 100, through a sending port 608, which may be in communication with the processor 601, and the memory 603.

The UE 103 may comprise a predicting unit 610, a transmitting unit 611, a receiving unit 613, a performing unit 615, a determining unit 618, a using unit 620 and other unit(s) 623 etc.

The UE 103 is adapted to, e.g. by means of the predicting unit 610, predict information related to at least one of the following failures:
a failure during operation with the serving cell; and
a failure accessing a neighbor cell.

The predicted information may comprise at least one of:
a predicted failure declaration,
a reason for the predicted failure declaration,
a time of the predicted failure declaration,
a probability of the predicted failure declaration,
a prediction of events related to the failure,
a prediction of a measurement value related to the failure,
a prediction of a timer value related to the failure, and
a prediction of a counter value related to the failure.

The predicted information may be related to at least one of a serving cell and a neighbor cell of the UE 103.

The predicted information may be based on measurements performed on downlink reference signal resources.

The UE 103 is adapted to, e.g. by means of the transmitting unit 611, transmit a message to a network node 101. The message indicates the predicted information.

The UE 103 may adapted to, e.g. by means of the receiving unit 613, receive a configuration of a measurement report from the network node 101. The configuration configuring one of:
periodic reporting of the measurement report; and
an entry condition triggering reporting of the measurement report.

The configuration may further configure the UE 103 to include an indication of the predicted information in the measurement report.

The UE 103 may be adapted to, e.g. by means of the transmitting unit 611, transmit the message comprising transmitting the measurement report according to the received configuration of the measurement report.

The UE 103 may be adapted to, e.g. by means of the receiving unit 613, receive a configuration of a prediction report from the network node 101. The configuration of the prediction report may configure at least one of:
what information to predict;
what to include in the prediction report;
an entry condition triggering the prediction report;
a period for reporting; and
an associated configuration of a measurement report to apply for the prediction report.

The UE 103 may be adapted to, e.g. by means of the transmitting unit 611, transmit the message comprising transmitting the prediction report according to the received configuration of the prediction report.

The configuration of the measurement or prediction report may comprise an identifier for each configured report, and the identifier may be comprised in the transmitted measurement or prediction report.

The UE 103 may adapted to, e.g. by means of the performing unit 615, perform an action in preparation for a re-establishment procedure, based on the predicted information.

The UE 103 may be adapted to, e.g. by means of the receiving unit 613, receive information indicating a prediction model to use for predicting the information from the network node 101.

The UE 103 may be adapted to, e.g. by means of the determining unit 618, determine UE parameter values comprising at least one of:
current measurement values,
sensor values,
connection parameter values,
mobility history parameter values, and
current time values.

The UE 103 may be adapted to, e.g. by means of the using unit 620, use the determined UE parameter values as input for a prediction model to use for predicting the information.

Those skilled in the art will also appreciate that the predicting unit 610, the transmitting unit 611, a receiving unit 613, the performing unit 615, the determining unit 618, the using unit 620 and other unit(s) 623 described above may refer to a combination of analog and digital circuits, and/or one or more processors configured with software and/or firmware, e.g., stored in memory, that, when executed by the one or more processors such as the processor 601, perform as described above. One or more of these processors, as well as the other digital hardware, may be comprised in a single Application-Specific Integrated Circuit (ASIC), or several processors and various digital hardware may be distributed among several separate components, whether individually packaged or assembled into a System-on-a-Chip (SoC).

The different units 610-623 described above may be implemented as one or more applications running on one or more processors such as the processor 601.

Thus, the methods described herein for the UE 103 may be respectively implemented by means of a computer program 625 product, comprising instructions, i.e., software code portions, which, when executed on at least one processor 601, cause the at least one processor 601 to carry out the actions described herein, as performed by the UE 103. The computer program 625 product may be stored on a computer-readable storage medium 628. The computer-readable storage medium 628, having stored thereon the computer program 625, may comprise instructions which, when executed on at least one processor 601, cause the at least one processor 601 to carry out the actions described herein, as performed by the UE 103. The computer-readable storage medium 628 may be a non-transitory computer-readable storage medium, such as a CD ROM disc, or a memory stick. The computer program 625 product may be stored on a carrier containing the computer program 625 just described, wherein the carrier is one of an electronic signal, optical signal, radio signal, or the first computer-readable storage medium 508, as described above.

The UE 103 may comprise a communication interface configured to facilitate communications between the UE 103 and other nodes or devices, e.g., the network node 101, or another structure. The interface may comprise a transceiver configured to transmit and receive radio signals over an air interface in accordance with a suitable standard.

The UE 103 may comprise the following arrangement depicted in FIG. 6b. The UE 103 may comprise a processing circuitry 630, e.g., one or more processors such as the processor 601, in the UE 103 and the memory 603. The UE 103 may also comprise a radio circuitry 633, which may comprise e.g., the receiving port 605 and the sending port 608. The processing circuitry 630 may be configured to, or operable to, perform the method actions according to FIG. 2 and FIG. 4, in a similar manner as that described in relation to FIG. 6a. The radio circuitry 630 may be configured to set up and maintain at least a wireless connection with the UE 103. Circuitry may be understood herein as a hardware component.

Hence, the present disclosure also relate to the UE 103 operative to operate in the wireless communications network 100. The UE 103 may comprise the processing circuitry 630 and the memory 603. The memory 603 comprises instructions executable by said processing circuitry 630. The UE 103 is operative to perform the actions described herein in relation to the UE 103, e.g. in FIG. 2 and FIG. 4.

The UE 103 may comprise a processor and a memory. The memory may comprise instructions executable by the processor. The processor may be adapted to:
predict information related to at least one of the following failures: a failure during operation with a serving cell; and a failure accessing a neighbour cell; and to
transmit a message to a network node 101, the message indicating the predicted information

The processor may be adapted to perform the method according as describe above, e.g. in FIG. 2 and FIG. 4.

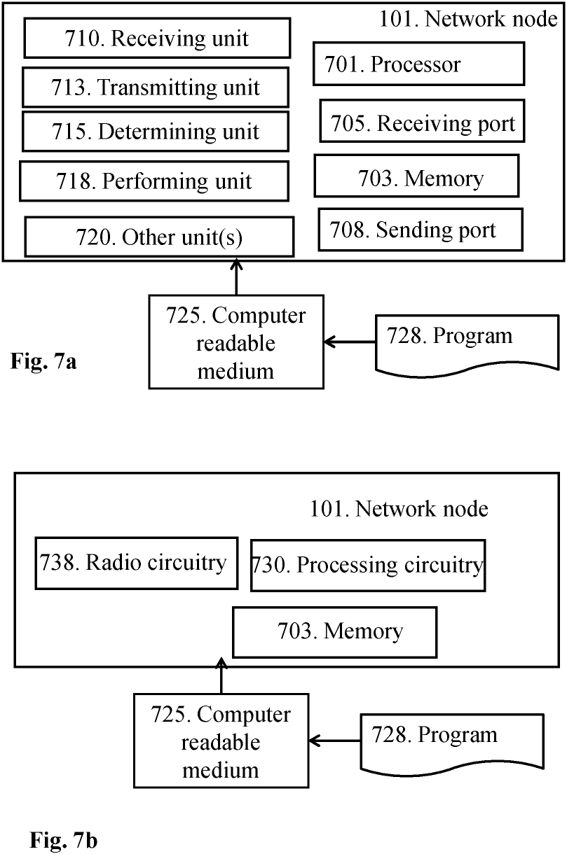

To perform the method steps shown in FIG. 5, the network node 101 may comprises an arrangement as shown in FIG. 7a or FIG. 7b. FIG. 7a and FIG. 7b depict two different examples in panels a) and b), respectively, of the arrangement that the network node 101 may comprise.

The present disclosure associated with the network node 101 may be implemented through one or more processors, such as a processor 701 in the network node 101 depicted in FIG. 7a, together with computer program code for performing the functions and actions described herein. A processor, as used herein, may be understood to be a hardware component. The program code mentioned above may also be provided as a computer program product, for instance in the form of a data carrier carrying computer program code for performing the present disclosure when being loaded into the network node 101. One such carrier may be in the form of a CD ROM disc. It is however feasible with other data carriers such as a memory stick. The computer program code may be provided as pure program code on a server and downloaded to the network node 101.

The network node 101 may comprise a memory 703 comprising one or more memory units. The memory 703 is arranged to be used to store obtained information, store data, configurations, schedulings, and applications etc. to perform the methods herein when being executed in the network node 101.

The network node 101 may receive information from, e.g., the UE 103, through a receiving port 705. The receiving port 705 may be, for example, connected to one or more antennas in network node 101. The network node 101 may receive information from another structure in the wireless communications network 100 through the receiving port 705. Since the receiving port 705 may be in communication with the processor 701, the receiving port 705 may then send the received information to the processor 701. The receiving port 705 may also be configured to receive other information.

The processor 701 in the network node 101 may be configured to transmit or send information to e.g., the UE 103, or another structure in the wireless communications network 100, through a sending port 708, which may be in communication with the processor 701, and the memory 703.

The network node 101 may comprise a receiving unit 710, a transmitting unit 713, a determining unit 715, a performing unit 718 and other unit(s) 720.

The network node 101 is adapted to, e.g. by means of the receiving unit 710, receive a message from a UE 103. The message indicates information predicted by the UE 103. The predicted information is related to at least one of the following failures:
a failure during operation with the serving cell; and
a failure accessing a neighbor cell.

The predicted information may comprise at least one of:
a predicted failure declaration,
a reason for the predicted failure declaration,
a time of the predicted failure declaration,
a probability of the predicted failure declaration,
a prediction of events related to the failure,
a prediction of a measurement value related to the failure,
a prediction of a timer value related to the failure, and
a prediction of a counter value related to the failure.

The predicted information may be related to at least one of a serving cell and a neighbor cell of the UE 103.

The network node 101 may be adapted to, e.g. by means of the transmitting unit 713, transmit a configuration of a measurement report to the UE 103, configuring one of:
periodic UE reporting of the measurement report; and
an entry condition triggering UE reporting of the measurement report.

The configuration may further configure the UE 103 to include an indication of the predicted information in the measurement report.

The network node 101 may be adapted to, e.g. by means of the receiving unit 710, receive the message comprising receiving the measurement report according to the transmitted configuration of the measurement report.

The network node 101 may be adapted to, e.g. by means of the transmitting unit 713, transmit a configuration of a prediction report to the UE 103, configuring at least one of:
what information to predict;
what to include in the prediction report;
an entry condition triggering the prediction report;
a period for reporting; and
an associated configuration of a measurement report to apply for the prediction report.

The network node 101 may be adapted to, e.g. by means of the receiving unit 710, receive the message comprises receiving the prediction report in accordance with the transmitted configuration.

The configuration of the measurement or prediction report may comprise an identifier for each configured report, and the identifier may be comprised in the received measurement or prediction report.

The network node 101 may be adapted to, e.g. by means of the determining unit 715, determine whether to reconfigure the UE 103 based on the received message.

The network node 101 may be adapted to, e.g. by means of the performing unit 718, perform the reconfiguration of the UE 103 when determined to reconfigure the UE 103.

The network node 101 may be adapted to, e.g. by means of the transmitting unit 713, transmit information indicating a prediction model to use for predicting the information to the UE 103.

Those skilled in the art will also appreciate that the receiving unit 710, a transmitting unit 713, a determining unit 715, a performing unit 718 and other unit(s) 720 described above may refer to a combination of analog and digital circuits, and/or one or more processors configured with software and/or firmware, e.g., stored in memory, that, when executed by the one or more processors such as the processor 701, perform as described above. One or more of these processors, as well as the other digital hardware, may be comprised in a single Application-Specific Integrated Circuit (ASIC), or several processors and various digital hardware may be distributed among several separate components, whether individually packaged or assembled into a System-on-a-Chip (SoC).

Also, the different units 710-720 described above may be implemented as one or more applications running on one or more processors such as the processor 701.

Thus, the methods described herein for the network node 101 may be respectively implemented by means of a computer program 725 product, comprising instructions, i.e., software code portions, which, when executed on at least one processor 701, cause the at least one processor 701 to carry out the actions described herein, as performed by the network node 101. The computer program 725 product may be stored on a computer-readable storage medium 728. The computer-readable storage medium 728, having stored thereon the computer program 725, may comprise instructions which, when executed on at least one processor 701, cause the at least one processor 701 to carry out the actions described herein, as performed by the network node 101. The computer-readable storage medium 728 may be a non-transitory computer-readable storage medium, such as a CD ROM disc, or a memory stick. The computer program 725 product may be stored on a carrier containing the computer program 725 just described, wherein the carrier is one of an electronic signal, optical signal, radio signal, or the second computer-readable storage medium 728, as described above.

The network node 101 may comprise a communication interface configured to facilitate communications between the network node 101 and other nodes or devices, e.g., the UE 103, or another structure. The interface may, for example, comprise a transceiver configured to transmit and receive radio signals over an air interface in accordance with a suitable standard.

The network node 101 may comprise the following arrangement depicted in FIG. 7b. The network node 101 may comprise a processing circuitry 730, e.g., one or more processors such as the processor 701, in the network node 101 and the memory 703. The network node 101 may also comprise a radio circuitry 738, which may comprise e.g., the receiving port 705 and the sending port 708. The processing circuitry 730 may be configured to, or operable to, perform the method actions according to FIG. 2 and FIG. 5 in a similar manner as that described in relation to FIG. 7a. The radio circuitry 730 may be configured to set up and maintain at least a wireless connection with the network node 101. Circuitry may be understood herein as a hardware component.

The network node 101 may be operative to operate in the wireless communications network 100. The network node 101 may comprise the processing circuitry 730 and the memory 703. The memory 703 comprises instructions executable by the processing circuitry 730. The network node 101 is operative to perform the actions described herein in relation to the network node 101, e.g., in FIG. 2 and FIG. 5.

The network node 101 may comprise a processor and a memory. The memory may comprise instructions executable by the processor. The processor may be adapted to receive a message from a UE 103. The message indicates information predicted by the UE 103. The predicted information being related to at least one of the following failures: a failure during operation with a serving cell; and a failure accessing a neighbour cell. The processor may be adapted to perform the method according as describe above, e.g. in FIG. 2 and FIG. 5.

### Further Extensions and Variations

A telecommunication network may be connected via an intermediate network to a host computer.

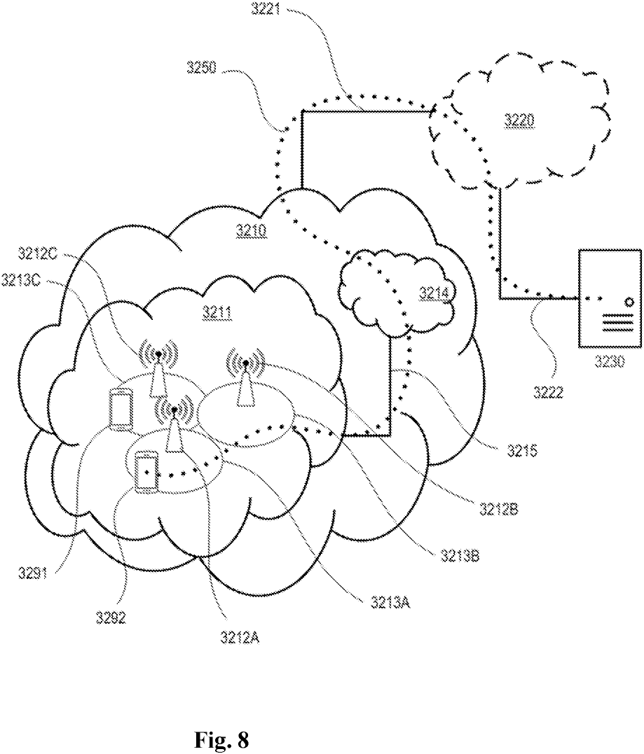

With reference to FIG. 8, the communication network comprises telecommunication network 3210 such as the wireless communication network 100, for example, a 3GPP-type cellular network, which comprises access network 3211, such as a radio access network, and core network 3214. Access network 3211 comprises a plurality of network nodes 105. For example, base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to core network 3214 over a wired or wireless connection 3215. A plurality of UEs, such as the UE 103 may be comprised in the communications system 100. In FIG. 320, a first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, it is equally applicable to a situation where a sole UE is in the coverage area or where a sole UE is connecting to the corresponding base station 3212. Any of the UEs 3291, 3292 may be considered examples of the UE 103.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider, or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communication system of FIG. 320 as a whole enables connectivity between the connected UEs 3291, 3292 and host computer 3230. The connectivity may be described as an Over-The-Top (OTT) connection 3250. Host computer 3230 and the connected UEs 3291, 3292 are configured to communicate data and/or signaling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded, e.g., handed over, to a connected UE 3291. Similarly, base station 3212 need not be aware of the future routing of an outgoing uplink communication originating from the UE 3291 towards the host computer 3230.

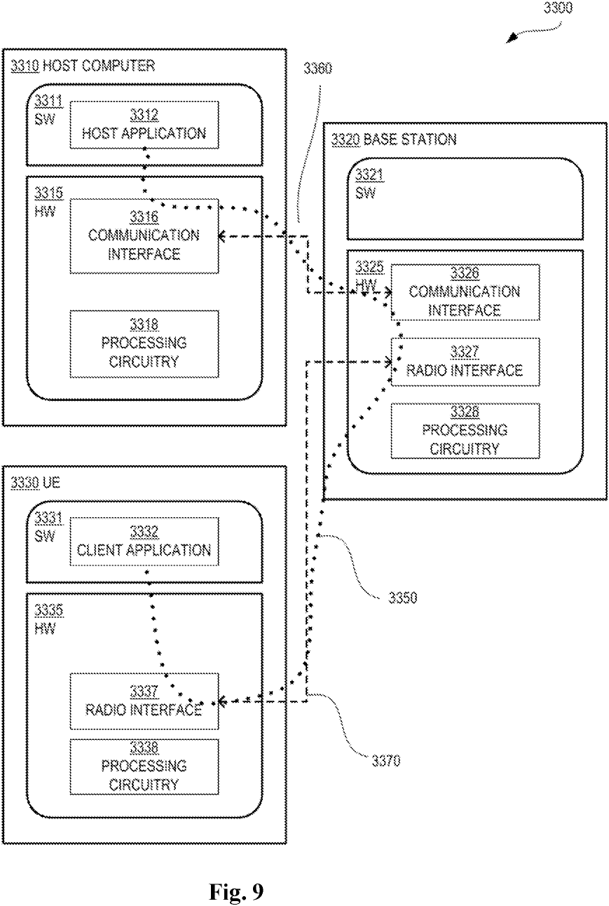

In relation to FIGS. 9-13 which are described next, it may be understood that the base station may be considered an example of the network node 101.

FIG. 9 illustrates an example of host computer communicating via a network node 101 with a UE 103 over a partially wireless connection.

The UE 103 and the network node 101, e.g., a base station and host computer discussed in the preceding paragraphs will now be described with reference to FIG. 9. In communication system 3330, such as the communications system 100, host computer 3310 comprises hardware 3315 comprising communication interface 3316 configured to set up and maintain a wired or wireless connection with an interface of a different communication device of communication system 3300. Host computer 3310 comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 comprises software 3311, which is stored in or accessible by host computer 3310 and executable by processing circuitry 3318. Software 3311 comprises host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

Communication system 3300 comprises the network node 101 exemplified in FIG. 9 as a base station 3320 provided in a telecommunication system and comprising hardware 3325 enabling it to communicate with host computer 3310 and with UE 3330. Hardware 3325 may comprise communication interface 3326 for setting up and maintaining a wired or wireless connection with an interface of a different communication device of communication system 3300, as well as radio interface 3327 for setting up and maintaining at least wireless connection 3370 with the UE 103, exemplified in FIG. 330 as a UE 3330 located in a coverage area served by base station 3320. Communication interface 3326 may be configured to facilitate connection 3360 to host computer 3310. Connection 3360 may be direct or it may pass through a core network (not shown in FIG. 330) of the telecommunication system and/or through one or more intermediate networks outside the telecommunication system. Hardware 3325 of base station 3320 comprises processing circuitry 3328, which may comprise one or more programmable processors, application-specific integrated circuits, field programmable gate arrays or combinations of these (not shown) adapted to execute instructions. Base station 3320 has software 3321 stored internally or accessible via an external connection.

Communication system 3300 comprises UE 3330 already referred to. It’s hardware 3335 may comprise radio interface 3337 configured to set up and maintain wireless connection 3370 with a base station serving a coverage area in which UE 3330 is currently located. Hardware 3335 of UE 3330 comprises processing circuitry 3338, which may comprise one or more programmable processors, application-specific integrated circuits, field programmable gate arrays or combinations of these (not shown) adapted to execute instructions. UE 3330 comprises software 3331, which is stored in or accessible by UE 3330 and executable by processing circuitry 3338. Software 3331 comprises client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides.

It is noted that host computer 3310, base station 3320 and UE 3330 illustrated in FIG. 330 may be similar or identical to host computer 3230, one of base stations 3212a, 3212b, 3212c and one of UEs 3291, 3292 of FIG. 320, respectively. This is to say, the inner workings of these entities may be as shown in FIG. 330 and independently, the surrounding network topology may be that of FIG. 320.

In FIG. 9, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may take decisions by which it dynamically changes the routing (e.g., on the basis of load balancing consideration or reconfiguration of the network).

There may be a wireless connection 3370 between UE 3330 and base station 3320. The present disclosure improve the performance of OTT services provided to UE 3330 using OTT connection 3350, in which wireless connection 3370 forms the last segment. The present disclosure may improve the spectrum efficiency, and latency, and thereby provide benefits such as reduced user waiting time, better responsiveness and extended battery lifetime.

A measurement procedure may be provided for the purpose of monitoring data rate, latency and other factors on which the present disclosure improve. There may be an optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3335 of UE 3330, or both. Sensors (not shown) may be deployed in or in association with communication devices through which OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 3350 may comprise message format, retransmission settings, preferred routing etc.; the reconfiguring need not affect base station 3320, and it may be unknown or imperceptible to base station 3320. Such procedures and functionalities may be known and practiced in the art. Measurements may involve proprietary UE signaling facilitating host computer 3310′s measurements of throughput, propagation times, latency and the like. The measurements may be implemented in that software 3311 and 3331 causes messages to be transmitted, in particular empty or ‘dummy’ messages, using OTT connection 3350 while it monitors propagation times, errors etc.

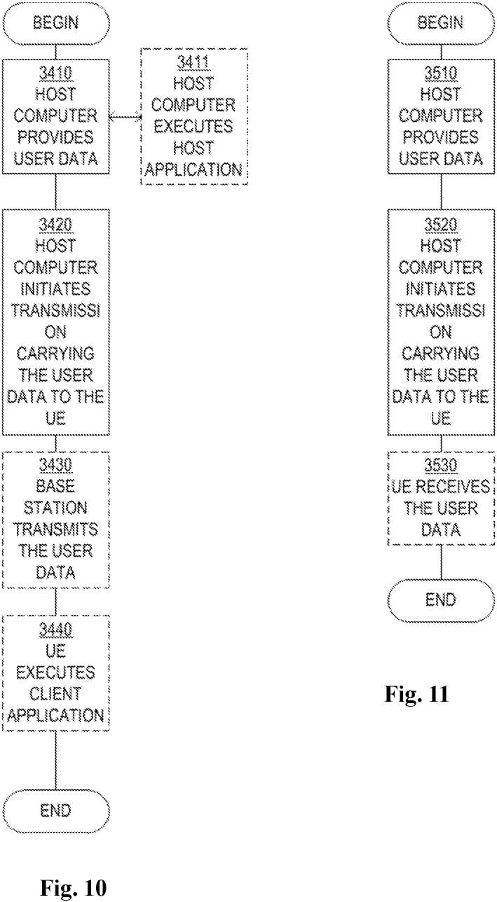

FIG. 10 illustrates an example of methods implemented in a communication system comprising a host computer, a base station and a UE. FIG. 10 is a flowchart illustrating a method implemented in a communication system. The communication system comprises a host computer, a base station and a UE which may be those described with reference to FIG. 8 and FIG. 9. For simplicity of the present disclosure, only drawing references to FIG. 10 will be comprised in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated. In step 3440 (which may also be optional), the UE executes a client application associated with the host application executed by the host computer.

FIG. 11 illustrates methods implemented in a communication system comprising a host computer, a base station and a UE. FIG. 11 is a flowchart illustrating a method implemented in a communication system. The communication system comprises a host computer, a base station and a UE which may be those described with reference to FIG. 8 and FIG. 9. For simplicity of the present disclosure, only drawing references to FIG. 11 will be comprised in this section. In step 3510 of the method, the host computer provides user data. In an optional substep (not shown) the host computer provides the user data by executing a host application. In step 3520, the host computer initiates a transmission carrying the user data to the UE. The transmission may pass via the base station. In step 3530 (which may be optional), the UE receives the user data carried in the transmission.

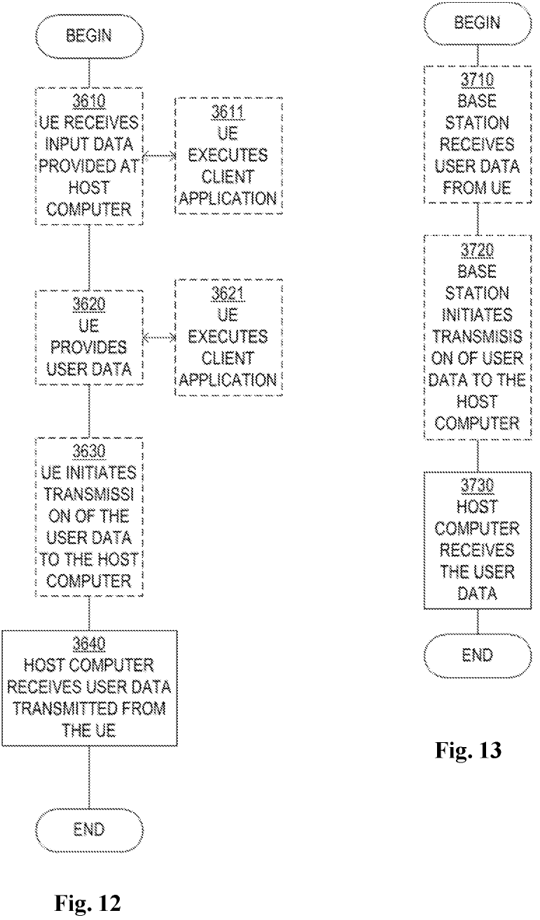

FIG. 12 illustrates methods implemented in a communication system comprising a host computer, a base station and a UE. FIG. 12 is a flowchart illustrating a method implemented in a communication system. The communication system comprises a host computer, a network node 101 and a UE 103 which may be those described with reference to FIG. 8 and FIG. 9. For simplicity of the present disclosure, only drawing references to FIG. 12 will be comprised in this section. In step 3610 (which may be optional), the UE 103 receives input data provided by the host computer. Additionally or alternatively, in step 3620, the UE 103 provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may consider user input received from the user. Regardless of the specific manner in which the user data was provided, the UE initiates, in substep 3630 (which may be optional), transmission of the user data to the host computer. In step 3640 of the method, the host computer receives the user data transmitted from the UE 103.

FIG. 13 illustrates methods implemented in a communication system comprising a host computer, a base station and a UE. FIG. 13 is a flowchart illustrating a method implemented in a communication system. The communication system comprises a host computer, a base station and a UE which may be those described with reference to FIG. 8 and FIG. 9. For simplicity of the present disclosure, only drawing references to FIG. 13 will be comprised in this section. In step 3710 (which may be optional), the base station receives user data from the UE. In step 3720 (which may be optional), the base station initiates transmission of the received user data to the host computer. In step 3730 (which may be optional), the host computer receives the user data carried in the transmission initiated by the base station.

The present disclosure may be summarized as follows:

A base station configured to communicate with a UE 103, the base station comprising a radio interface and processing circuitry configured to perform one or more of the actions described herein as performed by the network node 101.

A wireless communication network 100 comprising a host computer comprising:
processing circuitry configured to provide user data; and
a communication interface configured to forward the user data to a cellular network for transmission to a UE 103,
wherein the cellular network comprises a network node 101 having a radio interface and processing circuitry, the base station’s processing circuitry configured to perform one or more of the actions described herein as performed by the network node 101.

The communication system may comprise the network node 101.

The communication system may comprise the UE 103, wherein the UE 103 is configured to communicate with the network node 101.

The communication system, wherein:
the processing circuitry of the host computer is configured to execute a host application, thereby providing the user data; and
the UE 103 comprises processing circuitry configured to execute a client application associated with the host application.

A method implemented in a network node 101, comprising one or more of the actions described herein as performed by the network node 101.

A method implemented in a wireless communication network 100 comprising a host computer, a base station and a UE 103, the method comprising:
at the host computer, providing user data; and
at the host computer, initiating a transmission carrying the user data to the UE 103 via a cellular network comprising the network node 101, wherein the network node 101 performs one or more of the actions described herein as performed by the network node 101.

The method may comprise:
at the network node 101, transmitting the user data.

The user data may be provided at the host computer by executing a host application, and the method may comprise:
at the UE 103, executing a client application associated with the host application.

A UE 103 configured to communicate with a network node 101, the UE 103 comprising a radio interface and processing circuitry configured to perform one or more of the actions described herein as performed by the UE 103.

A wireless communication network 100 comprising a host computer comprising:
processing circuitry configured to provide user data; and
a communication interface configured to forward user data to a cellular network for transmission to a UE 103,
wherein the UE 103 comprises a radio interface and processing circuitry, the UE’s processing circuitry configured to perform one or more of the actions described herein as performed by the UE 103.

The communication system may comprise the UE 103.

The wireless communication network 100, wherein the cellular network comprises a network node 101 configured to communicate with the UE 103.

The wireless communication network 100, wherein:
the processing circuitry of the host computer is configured to execute a host application, thereby providing the user data; and
the UE’s processing circuitry is configured to execute a client application associated with the host application.

A method implemented in a UE 103, comprising one or more of the actions described herein as performed by the UE 103.

A method implemented in a wireless communication network 100 comprising a host computer, a network node 101 and a UE 103, the method comprising:
at the host computer, providing user data; and
at the host computer, initiating a transmission carrying the user data to the UE 103 via a cellular network comprising the base station, wherein the UE 103 performs one or more of the actions described herein as performed by the UE 103.

The method may comprise:
at the UE 103, receiving the user data from the network node 101.

A UE 103 configured to communicate with a network node 101, the UE 103 comprising a radio interface and processing circuitry configured to perform one or more of the actions described herein as performed by the UE 103.

A wireless communication network 100 comprising a host computer comprising:
a communication interface configured to receive user data originating from a transmission from a UE 103 to a network node 101,
wherein the UE 103 comprises a radio interface and processing circuitry, the UE’s processing circuitry configured to: perform one or more of the actions described herein as performed by the UE 103.

The wireless communication network 100 may comprise the UE 103.

The wireless communication network 100 may comprise the network node 101, wherein the network node 101 comprises a radio interface configured to communicate with the UE 103 and a communication interface configured to forward to the host computer the user data carried by a transmission from the UE 103 to the base station.

The wireless communication network 100, wherein:
the processing circuitry of the host computer is configured to execute a host application; and
the UE’s processing circuitry is configured to execute a client application associated with the host application, thereby providing the user data.

The wireless communication network 100, wherein:
the processing circuitry of the host computer is configured to execute a host application, thereby providing request data; and
the UE’s processing circuitry is configured to execute a client application associated with the host application, thereby providing the user data in response to the request data.

A method implemented in a UE 103, comprising one or more of the actions described herein as performed by the UE 103.

The method may comprise:
providing user data; and
forwarding the user data to a host computer via the transmission to the network node 101.

A method implemented in a wireless communication network 100 comprising a host computer, a network node 101 and a UE 103, the method comprising:
at the host computer, receiving user data transmitted to the network node 101 from the UE 103, wherein the UE 103 performs one or more of the actions described herein as performed by the UE 103.

The method may comprise:
at the UE 103, providing the user data to the network node 101.

The method may comprise:
at the UE 103, executing a client application, thereby providing the user data to be transmitted; and
at the host computer, executing a host application associated with the client application.

The method may comprise:
at the UE 103, executing a client application; and
at the UE 103, receiving input data to the client application, the input data being provided at the host computer by executing a host application associated with the client application,
wherein the user data to be transmitted is provided by the client application in response to the input data.

A network node 101 configured to communicate with a UE 103, the network node 101 comprising a radio interface and processing circuitry configured to perform one or more of the actions described herein as performed by the network node 101.

A wireless communication network 100 comprising a host computer comprising a communication interface configured to receive user data originating from a transmission from a UE 103 to a base station, wherein the network node 101 comprises a radio interface and processing circuitry, the base station’s processing circuitry configured to perform one or more of the actions described herein as performed by the network node 101.

The wireless communication network 100 may comprise the network node 101.

The wireless communication network 100 may comprise the UE 103, wherein the UE 103 is configured to communicate with the network node 101.

The wireless communication network 100 wherein:
the processing circuitry of the host computer is configured to execute a host application;
the UE 103 is configured to execute a client application associated with the host application, thereby providing the user data to be received by the host computer.

A method implemented in a network node 101, comprising one or more of the actions described herein as performed by any of the network node 101.

A method implemented in a communication system comprising a host computer, a network node 101 and a UE 103, the method comprising:
at the host computer, receiving, from the network node 101, user data originating from a transmission which the base station has received from the UE 103, wherein the UE 103 performs one or more of the actions described herein as performed by the UE 103.

The method may comprise:
at the network node 101, receiving the user data from the UE 103.

The method may comprise:
at the network node 101, initiating a transmission of the received user data to the host computer.

Even if most of the examples referred herein are for NR, the present disclosure may be applied to any system, e.g., in the 6G context, where AI and ML is envisioned to play a more impactful role when it comes to the design of protocols.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step.

In general, the usage of “first”, “second”, “third”, “fourth”, and/or “fifth” herein may be understood to be an arbitrary way to denote different elements or entities, and may be understood to not confer a cumulative or chronological character to the nouns they modify, unless otherwise noted, based on context.

The present disclosure is not limited to the above. Various alternatives, modifications and equivalents may be used. Therefore, disclosure herein should not be taken as limiting the scope. A feature may be combined with one or more other features.

The term “at least one of A and B” should be understood to mean “only A, only B, or both A and B.”, where A and B are any parameter, number, indication used herein etc.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

The term “configured to” used herein may also be referred to as “arranged to”, “adapted to”, “capable of” or “operative to”.

The steps of the methods may be performed in another order than the order in which they appear herein.

1-44. (canceled)

45. A method performed by a User Equipment (UE) of a wireless communications network, the method comprising:
receiving a configuration of a prediction report from the network node, the configuration of the prediction report configuring at least one of: what information to predict, what to include in the prediction report, an entry condition triggering the prediction report, a period for reporting, and an associated configuration of a measurement report to apply for the prediction report;
predicting information related to a failure during operation with a serving cell and/or a failure accessing a neighbour cell; and
transmitting a message to a network node, the message indicating the predicted information, wherein transmitting the message comprises transmitting the prediction report according to the received configuration of the prediction report.

46. The method according to claim 45, wherein the configuration of the prediction report comprises an identifier for each configured report, and wherein the identifier is comprised in the transmitted prediction report.

47. The method according to claim 45, further comprising performing an action in preparation for a re-establishment procedure, based on the predicted information.

48. The method according to claim 45, wherein the predicted information is based on measurements performed on downlink reference signal resources.

49. The method according to claim 45, further comprising receiving, from the network node, information indicating a prediction model to use for predicting the information.

50. The method according to claim 45, wherein predicting the information comprises:
determining UE parameter values comprising at least one of: current measurement values, sensor values, connection parameter values, mobility history parameter values, and current time values; and
using the determined UE parameter values as input for a prediction model to use for predicting the information.

51. A method performed by a network node of a wireless communications network, the method comprising:
transmitting a configuration of a prediction report to a User Equipment (UE), configuring at least one of: what information to predict, what to include in the prediction report, an entry condition triggering the prediction report, a period for reporting, and an associated configuration of a measurement report to apply for the prediction report; and
receiving a message from the UE, the message indicating information predicted by the UE, the predicted information being related to a failure during operation with a serving cell and/or and a failure accessing a neighbour cell, wherein receiving the message comprises receiving the prediction report in accordance with the transmitted configuration.

52. The method according to claim 51, wherein the configuration of the prediction report comprises an identifier for each configured report, and wherein the identifier is comprised in the received prediction report.

53. The method according to claim 51, further comprising:
determining whether to reconfigure the UE based on the received message; and
performing reconfiguration of the UE when determined to reconfigure the UE.

54. The method according to claim 51, further comprising transmitting, to the UE, information indicating a prediction model to use for predicting the information.

55. The method according to claim 51, wherein the predicted information comprises at least one of: a predicted failure declaration, a reason for the predicted failure declaration, a time of the predicted failure declaration, a probability of the predicted failure declaration, a prediction of events related to the failure, a prediction of a measurement value related to the failure, a prediction of a timer value related to the failure, and a prediction of a counter value related to the failure.

56. A User Equipment (UE) of a wireless communications network, wherein the UE comprises a processor and a memory, wherein the memory comprises instructions executable by the processor, whereby the UE is configured to:
receive a configuration of a prediction report from the network node, the configuration of the prediction report configuring at least one of: what information to predict, what to include in the prediction report, an entry condition triggering the prediction report, a period for reporting, and an associated configuration of a measurement report to apply for the prediction report;
predict information related to a failure during operation with a serving cell and/or a failure accessing a neighbour cell; and
transmit a message to a network node, the message indicating the predicted information, wherein the UE is configured to transmit the prediction report according to the received configuration of the prediction report.

57. The UE according to claim 56, wherein the configuration of the prediction report comprises an identifier for each configured report, and wherein the identifier is comprised in the transmitted prediction report.

58. The method according to claim 56, wherein the memory comprises instructions executable by the processor whereby the UE is further configured to perform an action in preparation for a re-establishment procedure, based on the predicted information.

59. The method according to claim 56, wherein the predicted information is based on measurements performed on downlink reference signal resources.

60. The method according to claim 56, wherein the memory comprises instructions executable by the processor whereby the UE is further configured to receive, from the network node, information indicating a prediction model to use for predicting the information.

61. The method according to claim 56, wherein the memory comprises instructions executable by the processor whereby the UE is configured to predict the information by:
determining UE parameter values comprising at least one of: current measurement values, sensor values, connection parameter values, mobility history parameter values, and current time values; and
using the determined UE parameter values as input for a prediction model to use for predicting the information.

62. A network node of a wireless communications network, the network node comprises a processor and a memory, wherein the memory comprises instructions executable by the processor, whereby the network node is configured to:
transmit a configuration of a prediction report to the UE, configuring at least one of: what information to predict, what to include in the prediction report, an entry condition triggering the prediction report, a period for reporting, and an associated configuration of a measurement report to apply for the prediction report; and
receive a message from a User Equipment (UE), the message indicating information predicted by the UE, the predicted information being related to a failure during operation with a serving cell and/or and a failure accessing a neighbour cell, wherein reception of the message comprises reception of the prediction report in accordance with the transmitted configuration.

63. The network node according to claim 62, wherein the configuration of the prediction report comprises an identifier for each configured report, and wherein the identifier is comprised in the received prediction report.

64. The network node according to claim 62, wherein the memory comprises instructions executable by the processor whereby the network node is further configured to:
determine whether to reconfigure the UE based on the received message; and
perform reconfiguration of the UE when determined to reconfigure the UE.
